(19) United States
(12) Patent Application Publication
(10) Pub. No.: US 2025/0273843 A1
(43) Pub. Date: Aug. 28, 2025

(54) ANTENNA INCLUDED IN DISPLAY MODULE AND ELECTRONIC DEVICE INCLUDING SAME

(71) Applicant: Samsung Electronics Co., Ltd., Suwon-si (KR)

(72) Inventors: Jaehoon JO, Suwon-si (KR); Hosaeng KIM, Suwon-si (KR); Seongjin PARK, Suwon-si (KR); Sumin YUN, Suwon-si (KR)

(21) Appl. No.: 19/207,837

(22) Filed: May 14, 2025

Related U.S. Application Data
(63) Continuation of application No. PCT/KR2023/016210, filed on Oct. 19, 2023.

(30) Foreign Application Priority Data
Nov. 14, 2022 (KR) 10-2022-0151805
Jan. 5, 2023 (KR) 10-2023-0001826

(51) Int. Cl. H01Q 1/12; H01Q 1/48

(52) U.S. Cl. CPC H01Q 1/1271; H01Q 1/48

(57) ABSTRACT

An electronic device comprises: a housing comprising a first plate arranged in a first direction, a second plate arranged in a second direction opposite to the first direction, and a side-surface bezel surrounding at least a portion of a space between the first and second plates; a display module comprising at least one dielectric layer arranged in the second direction in at least a partial area of the first plate; and an antenna arranged on the dielectric layer. The antenna may comprise: an antenna member including an array of a plurality of mesh-shaped conductive patterns; at least one antenna pattern formed on the antenna member; and at least one first dummy pattern arranged symmetrically in the vertical direction of the polarization generated from the antenna pattern and arranged to be spaced apart from the antenna pattern.

### CROSS-REFERENCE TO RELATED APPLICATIONS

This application is a continuation of International Application No. PCT/KR2023/016210 designating the United States, filed on Oct. 19, 2023, in the Korean Intellectual Property Receiving Office and claiming priority to Korean Patent Application Nos. 10-2022-0151805, filed on Nov. 14, 2022, and 10-2023-0001826, filed on Jan. 5, 2023, in the Korean Intellectual Property Office, the disclosures of each of which are incorporated by reference herein in their entireties.

### BACKGROUND

### Field

The disclosure relates to an antenna arranged in a display module of an electronic device such as a mobile device.

### Description of Related Art

An electronic device can include at least one display module, and the display module can be disposed on a bottom surface of a window and visually display various information through the window. The display module can include at least one antenna device. For example, the antenna device arranged in the display module can be at least one patch antenna arranged between the window and a display panel.

Such an antenna can include at least one antenna pattern formed on a mesh type antenna member.

To suppress the generation of surface waves interfering with antenna performance, a method has been used in which a ground wall is arranged around the antenna, or the surface waves spreading around the antenna are absorbed by a grounded structure through an array of cells having an LC resonance structure.

As an antenna arranged in a display module operates, surface waves can be generated in a direction perpendicular to polarization generated from an antenna radiator, and the generation of surface waves can still cause the degradation of antenna performance. However, the antenna included in the display module can be difficult to form a conductive connection structure such as Via between a panel serving as the ground and an antenna film.

For example, in an antenna structure arranged in a display module of an electronic device, when a window of a thick glass material compared to wavelength is used, and an antenna operates as a single antenna, the adverse effect on surface waves can be large, and a radiation pattern of the antenna can be distorted.

The technical task to be addressed by this disclosure is not limited to the technical tasks mentioned above, and other technical tasks not mentioned may be clearly understood by those skilled in the art to which the disclosure pertains from the following description.

### SUMMARY

Embodiments of the disclosure provide an antenna and an electronic device including the same, which may arrange at least one dummy pattern in a direction perpendicular to the polarization of an antenna pattern, and efficiently arrange the dummy pattern, thereby reducing a pattern distortion of an antenna radiator.

Embodiments of the disclosure provide an antenna and an electronic device including the same, which may arrange an antenna in a display module, and utilize a portion (e.g., display panel frame) of a structure of the display module as a ground pattern portion.

According to an example embodiment of the disclosure, an electronic device may include: a housing including a first plate arranged in a first direction, a second plate arranged in a second direction opposite to the first direction, and a side-surface member comprising a bezel surrounding at least a portion of a space between the first plate and the second plate, a display module including at least one dielectric layer arranged in the second direction in at least a partial area of the first plate, and an antenna disposed on the dielectric layer. The antenna may include an antenna member including an array of a plurality of mesh-shaped conductive patterns, at least one antenna pattern formed on the antenna member, and at least one first dummy pattern arranged to be spaced apart from the antenna pattern in a direction perpendicular to polarization generated from the antenna pattern.

An antenna of various example embodiments of the disclosure may have at least one dummy pattern arranged in a direction perpendicular to polarization generated from an antenna pattern, and reduce surface waves interfering with a radiation operation of the antenna. Accordingly, the antenna of an example embodiment of the disclosure may reduce a distortion of a radiation pattern of the antenna pattern and increase an antenna radiation gain.

An antenna of various example embodiments of the disclosure may be arranged in a display module, and utilize the display module (e.g., display panel layer) as a ground pattern portion for suppressing surface waves.

Effects obtainable from the disclosure are not limited to the effects mentioned above, and other effects not mentioned may be clearly understood by those skilled in the art to which the disclosure pertain from the description below.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a front perspective view of an example electronic device according to various embodiments;

FIG. 2 is a rear perspective view illustrating of an example electronic device according to various embodiments;

FIG. 3 is an exploded perspective view illustrating an internal structure of an example electronic device according to various embodiments;

FIG. 4 is a partial cross-sectional view illustrating a state in which an antenna is arranged in an electronic device according to various embodiments;

FIGS. 5A and 5B are cross-sectional views each illustrating a state in which an antenna is arranged in a display module according to various embodiments;

FIGS. 6, 7, 8, 9, 10 and 11 are diagrams illustrating enlarged plan views of an antenna having at least one dummy pattern according to various embodiments;

FIG. 12 is a diagram including a graph illustrating radiation characteristics of a second antenna and a third antenna when an antenna is arranged as a multi-antenna according to various embodiments;

FIGS. 13 and 14 are diagrams illustrating plan views of an antenna having at least one dummy pattern according to various embodiments;

FIGS. 15 and 16 are diagrams including graphs comparing the radiation characteristics of an antenna without a dummy pattern and an antenna with a dummy pattern according to various embodiments;

FIG. 17 is a diagram illustrating an example antenna array having various types of dummy patterns according to various embodiments;

FIGS. 18, 19, 20, 21, 22, 23, 24, 25, 26, 27, 28, 29, 30, 31, 32, 33, 34, 35, 36, 37, 38, 39, 40, 41, 42, 43, 44 and 45 are diagrams illustrating enlarged plan views of an antenna having at least one dummy pattern according to various embodiments.

In relation to the description of the drawings, the same or similar reference numerals may be used for the same or similar components.

### DETAILED DESCRIPTION

Various embodiments of the disclosure are described below with reference to the accompanying drawings. However, these are not intended to limit the disclosure to a specific embodiment, and should be understood as including various modifications, equivalents, and/or alternatives of the various embodiments of the disclosure.

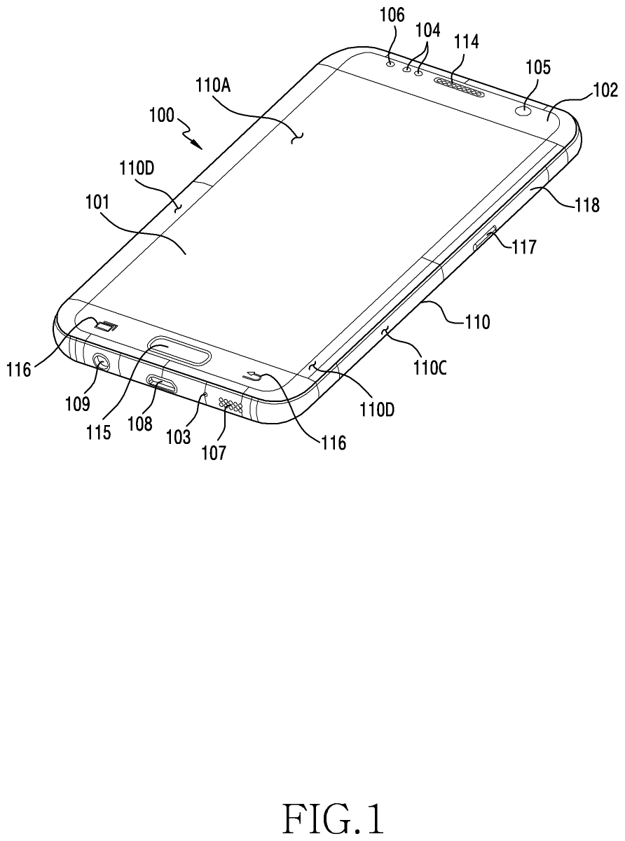

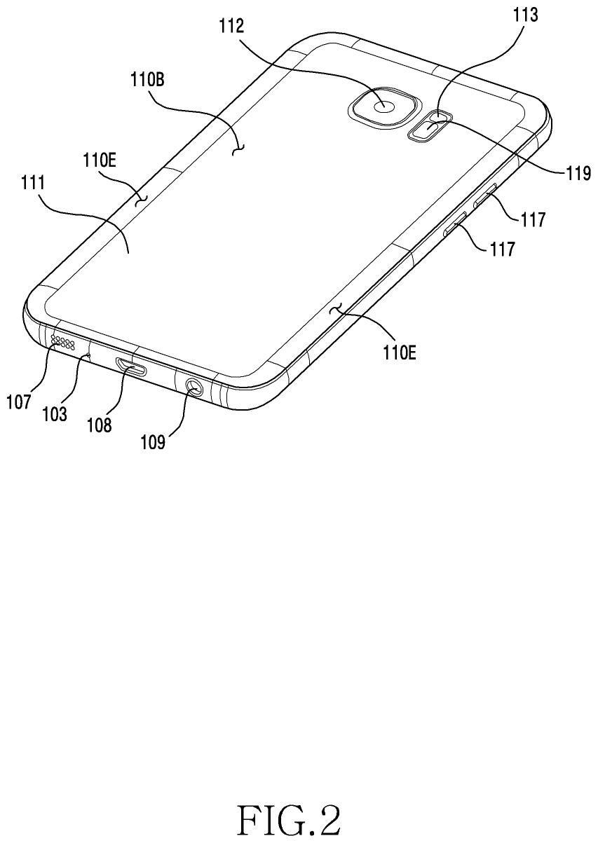

Referring to FIGS. 1 and 2, an electronic device 100 of an embodiment may include a housing 110 including a first surface (or front surface) 110A, a second surface (or rear surface) 110B, and a side surface 110C surrounding a space between the first surface 110A and the second surface 110B. In an embodiment (not shown), the housing may also refer to a structure forming a portion of the first surface 110A, the second surface 110B, and the side surface 110C of FIG. 1. According to an embodiment, the first surface 110A may be formed by a front plate 102 (e.g., glass plate including various coating layers, or polymer plate) that is at least partially substantially transparent. The second surface 110B may be formed by a rear plate 111 that is substantially opaque. The rear plate 111 may be formed by, for example, coated or colored glass, ceramic, polymer, metal (e.g., aluminum, stainless steel (STS), or magnesium), or a combination of at least two of the foregoing materials. The side surface 110C may be formed by a side bezel structure (or “side-surface member”) 118 that is coupled to the front plate 102 and the rear plate 111 and includes a metal and/or a polymer. In various embodiments, the rear plate 111 and the side bezel structure 118 may be formed integrally and may comprise the same material (e.g., metal material such as aluminum).

In the illustrated embodiment, the front plate 102 may include, at both ends of long edges of the front plate, a first area 110D that extends seamlessly from the first surface 110A toward the rear plate. In the illustrated embodiment (see FIG. 2), the rear plate 111 may include, at both ends of long edges, a second area 110E that extends seamlessly from the second surface 110B toward the front plate. In various embodiments, the front plate or the rear plate may include only one of the first area or the second area. In the above embodiments, when viewed from the side surface of the electronic device, the side bezel structure may have a first thickness (or width) for a side surface not including the first area or second area, and have a second thickness less than the first thickness for a side surface including the first area or second area.

According to an embodiment, the electronic device 100 may include at least one of a display 101, audio modules 103, 107, and 114, sensor modules 104 and 119, camera modules 105, 112, and 113, key input devices 115, 116, and 117, an indicator 106, and connector holes 108 and 109. In various embodiments, the electronic device 100 may omit at least one (e.g., key input devices 115, 116, and 117, or indicator 106) of the components or may additionally include other components.

In an embodiment, the display 101 may be visible through, for example, a significant portion of the front plate 102. In various embodiments, at least a portion of the display 101 may be visible through the front plate 102 that forms the first surface 110A and the first area 110D of the side surface 110C. The display 101 may be coupled to or arranged adjacent to a touch sensing circuit, a pressure sensor capable of measuring the intensity (pressure) of a touch, and/or a digitizer detecting a magnetic field type stylus pen. In various embodiments, at least some of the sensor modules 104 and 119 and/or at least some of the key input device 115, 116, and 117 may be arranged in the first area 110D and/or the second area 110E.

According to an embodiment, the audio modules 103, 107, and 114 may include a microphone hole 103 and speaker holes 107 and 114. A microphone for acquiring external sound may be arranged inside the microphone hole 103, and in various embodiments, a plurality of microphones may be arranged and detect the direction of sound. The speaker holes 107 and 114 may include an external speaker hole 107 and a call receiver hole 114. In various embodiments, the speaker holes 107 and 114 and the microphone hole 103 may be implemented as one hole, or a speaker (e.g., piezo speaker) may be included without the speaker holes 107 and 114.

According to an embodiment, the sensor modules 104 and 119 may generate an electric signal or data value corresponding to an internal operating state of the electronic device 100 or an external environmental state. The sensor modules 104 and 119 may include, for example, a first sensor module 104 (e.g., proximity sensor) and/or second sensor module (not shown) (e.g., fingerprint sensor) arranged in the first surface 110A of the housing 110, and/or a third sensor module 119 (e.g., HRM sensor) arranged in the second surface 110B of the housing 110. The fingerprint sensor may be arranged in the second surface 110B as well as the first surface 110A (e.g., home key button 115) of the housing 110. The electronic device 100 may further include at least one of a non-shown sensor module, for example, a gesture sensor, a gyro sensor, a pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera modules 105, 112, and 113 may include a first camera device 105 arranged in the first surface 110A of the electronic device 100, a second camera device 112 arranged in the second surface 110B, and/or a flash 113. The camera modules 105 and 112 may include one or more lenses, an image sensor, and/or an image signal processor. The flash 113 may include, for example, a light-emitting diode or a xenon lamp. In various embodiments, two or more lenses (wide-angle and telephoto lenses) and image sensors may be arranged in one surface of the electronic device 100.

In an embodiment, the key input devices 115, 116, and 117 may include a home key button 115 arranged in the first surface 110A of the housing 110, a touch pad 116 arranged around the home key button 115, and/or a side key button 117 arranged in the side surface 110C of the housing 110. In other embodiments, the electronic device 100 may not include some or all of the above-mentioned key input devices 115, 116, and 117, and the key input devices 115, 116, and 117 not included may be implemented in other forms such as soft keys on the display 101.

According to an embodiment, the indicator 106 may be arranged, for example, in the first surface 110A of the housing 110. The indicator 106 may provide, for example, status information of the electronic device 100 in the form of light, and may include an LED.

According to an embodiment, the connector holes 108 and 109 may include a first connector hole 108 capable of accommodating a connector (for example, USB connector) for transmitting and receiving power and/or data with an external electronic device, and/or a second connector hole (or earphone jack) 109 capable of accommodating a connector for transmitting and receiving audio signals with the external electronic device.

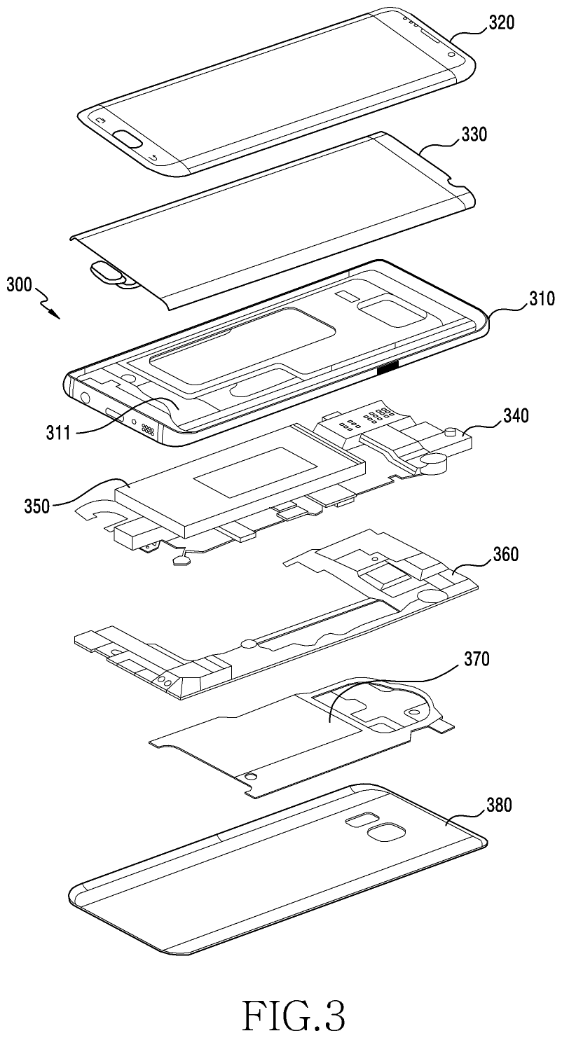

Referring to FIG. 3, an electronic device 300 may include a side bezel structure 310, a first support member 311 (e.g., bracket), a front plate 320, a display 330, a printed circuit board 340, a battery 350, a second support member 360 (e.g., rear case), an antenna 370, and a rear plate 380. In various embodiments, the electronic device 300 may omit at least one (e.g., first support member 311 or second support member 360) of the components or may additionally include other components. At least one of the components of the electronic device 300 may be identical to or similar to at least one of the components of the electronic device 100 of FIG. 1 or 2, and a repeated description will be omitted below.

According to an embodiment, the first support member 311 may be arranged inside the electronic device 300 and be connected to the side bezel structure 310, or may be formed integrally with the side bezel structure 310. The first support member 311 may be formed of, for example, a metal material and/or a non-metallic (e.g., polymer) material. The display 330 may be coupled to one surface of the first support member 311, and the printed circuit board 340 may be coupled to the other surface of the first support member 311. The printed circuit board 340 may be equipped with a processor, a memory, and/or an interface. The processor may include, for example, one or more of a central processing unit, an application processor, a graphics processing unit, an image signal processor, a sensor hub processor, or a communication processor.

According to an embodiment, the memory may include, for example, a volatile memory or a non-volatile memory.

In an embodiment, the interface may include, for example, a high definition multimedia interface (HDMI), a universal serial bus (USB) interface, an SD card interface, and/or an audio interface. The interface may electrically or physically connect the electronic device 300 to an external electronic device, and may include, for example, a USB connector, an SD card/MMC connector, or an audio connector.

According to an embodiment, the battery 350 is a device for supplying power to at least one component of the electronic device 300, and may include, for example, a non-rechargeable primary battery, a rechargeable secondary battery, or a fuel cell. At least a portion of the battery 350 may be disposed substantially on the same plane as, for example, the printed circuit board 340. The battery 350 may be arranged integrally within the electronic device 100, and may also be arranged detachably from the electronic device 100.

According to an embodiment, the antenna 370 may be arranged between the rear plate 380 and the battery 350. The antenna 370 may include, for example, a near field communication (NFC) antenna, a wireless charging antenna, and/or a magnetic secure transmission (MST) antenna. The antenna 370 may, for example, perform short-range communication with an external device or wirelessly transmit and receive power required for charging. In an embodiment, an antenna structure may be formed by part of the side bezel structure 310 and/or the first support member 311 or a combination thereof.

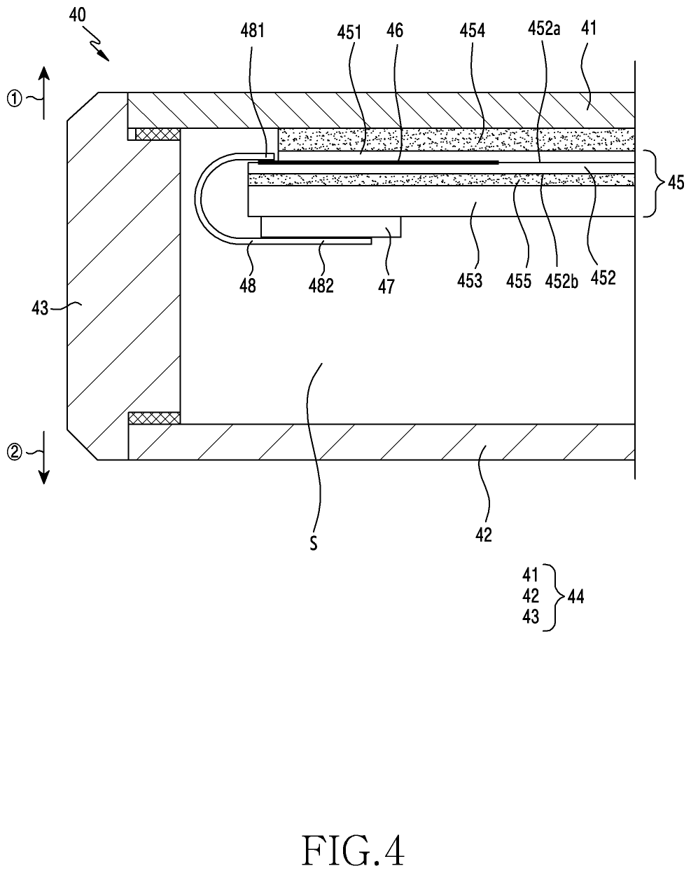

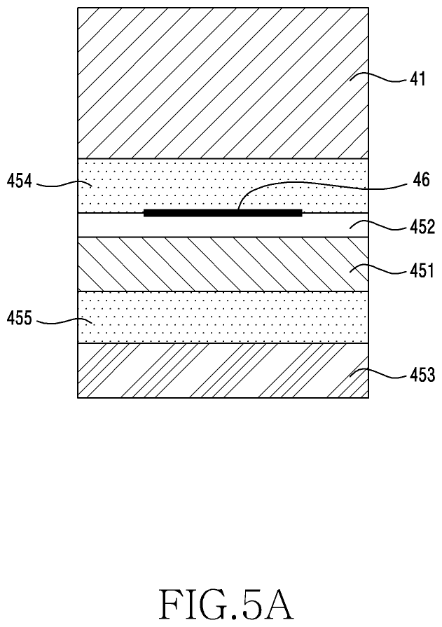

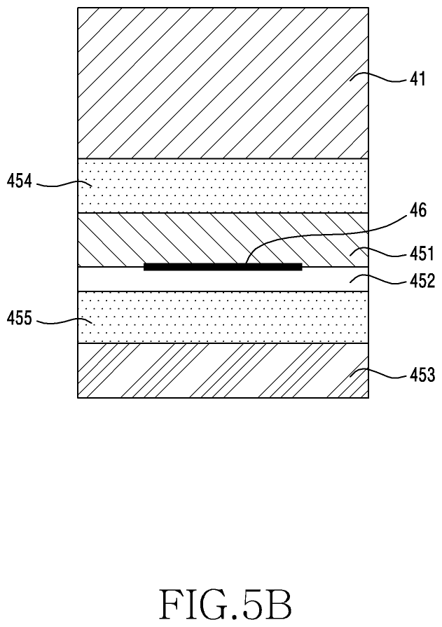

Referring to FIGS. 4, 5A and 5B, according to an embodiment, an electronic device 40 may include a housing 44 in which various components are accommodated. According to an embodiment, the housing 44 may include a first plate 41 (e.g., window) arranged in a first direction (\textcircled{1}), a second plate 42 (e.g., back cover) arranged in a second direction (\textcircled{2}) opposite to the first direction (\textcircled{1}), or a side-surface member 43 surrounding at least a portion of a space between the first plate 41 and the second plate 42. For example, the first direction (\textcircled{1}) may be a front direction, and the second direction (\textcircled{2}) may be a rear direction.

According to an embodiment, the electronic device 40 may include a display module 45 arranged inside the housing 44. According to an embodiment, the display module 45 may include a polarizing layer 451, a dielectric layer 452, or a display panel 453. According to an embodiment, the polarizing layer 451, the dielectric layer 452, and the display panel 453 may be arranged in a laminated structure.

According to an embodiment, the polarizing layer 451 may be attached to the first plate 41 by a first adhesive layer 454. For example, the first adhesive layer 454 may include any one of an optical clear adhesive (OCA) or an optical clear resin (OCR).

According to an embodiment, the dielectric layer 452 may be a film on which a display antenna 46 is disposed, and may include a first surface 452a facing in the first direction (\textcircled{1}) and a second surface 452b facing in the second direction (\textcircled{2}). According to an embodiment, the dielectric layer 452 may include an insulating film in the form of a transparent thin film.

For example, the dielectric layer 452 may include a transparent resin film including a polyester resin such as polyethylene terephthalate, polyethylene isophthalate, polyethylene naphthalate, or polybutylene terephthalate, a cellulose resin such as diacetyl cellulose or triacetyl cellulose, a polycarbonate resin, an acrylic resin such as polymethyl (meth) acrylate or polyethyl (meth) acrylate, a styrene resin such as polystyrene or an acrylonitrile-styrene copolymer, a polyolefin resin such as polyethylene, polypropylene, a polyolefin having a cyclo - or norbornene structure, or an ethylene-propylene copolymer, a vinyl chloride resin, an amide resin such as nylon or an aromatic polyamide, an imide resin, a polyether sulfone resin, a sulfone resin, a polyether ether ketone resin, a sulfated polyphenylene resin, a vinyl alcohol resin, vinylidene chloride resin, vinyl butyral resin, allylate resin, polyoxymethylene resin, epoxy resin, urethane or acrylic urethane resin, or silicone resin. These may be used alone or in combination of two or more.

According to an embodiment, the display module 45 may include the display panel 453 attached to the dielectric layer 452 by a second adhesive layer 455. For example, the second adhesive layer 455 may include either an optical clear adhesive (OCA) or an optical clear resin (OCR). According to an embodiment, the display module 45 may include the display antenna 46. For example, the display antenna 46 may be named a display antenna in that the antenna is arranged in the display module 45. Hereinafter, the display antenna 46 will be defined as an antenna.

According to an embodiment, a plurality of semiconductor chips 47 may be disposed in a system-in-package (Sip) manner on a bottom surface, which faces the second direction (\textcircled{2}) (for example, downward direction), of the display panel 453. For example, the semiconductor chip 47 may include one or more chips or a plurality of chips among a radio frequency integrated circuit (RFIC), a power management IC (PMIC), or a lumped element.

According to an embodiment, the display antenna 46 may be electrically connected to the semiconductor chips 47. For example, the display antenna 46 may be electrically connected to at least one semiconductor chip 47 using a flexible printed circuit board (FPCB) 48. According to an embodiment, one end portion 481 of the flexible printed circuit board 48 may be bonded to the display antenna 46 in a bonding manner, and the other end portion 482 may be bonded to the semiconductor chip 47 in a surface mount device (SMD) manner.

Referring to FIG. 5A, according to an embodiment, the dielectric layer 452 on which the antenna 46 is disposed may be disposed on (e.g., first direction (\textcircled{1})) the polarizing layer 451, and the antenna 46 may be positioned above (e.g., first direction (\textcircled{1})) the polarizing layer 451 and the display panel 453. According to an embodiment, the antenna 46 may face the first plate 41.

Referring to FIG. 5B, according to an embodiment, the dielectric layer 452 on which the antenna 46 is disposed may be disposed beneath (e.g., second direction (\textcircled{2})) the polarizing layer 451, and the antenna 46 may be positioned between the polarizing layer 451 and the display panel 453. According to an embodiment, the antenna 46 may directly face the polarizing layer 451.

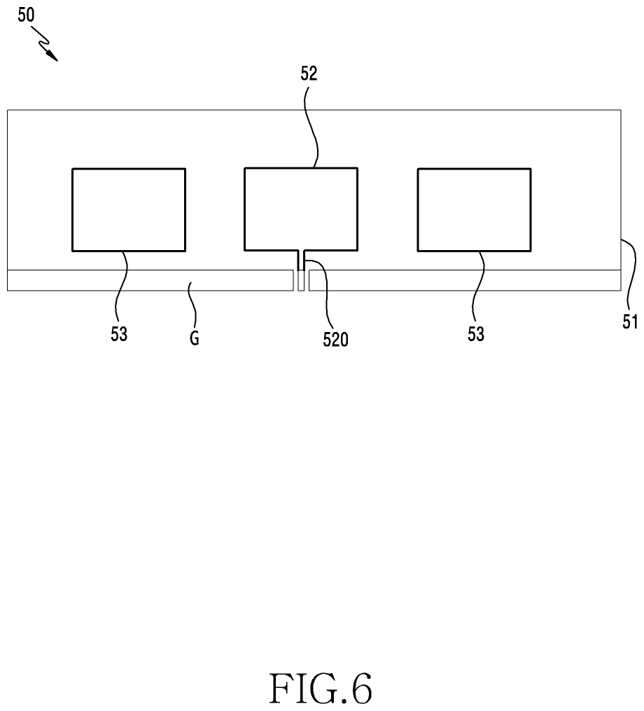

Referring to FIG. 6, an antenna 50 (e.g., antenna 46 illustrated in FIG. 4) disposed on the dielectric layer 452 of an embodiment may include an antenna member 51 and an antenna pattern 52. According to an embodiment, the antenna 50 may generate surface waves in a direction perpendicular to the polarization of the antenna. According to an embodiment, as the surface waves get distant away from the antenna pattern 52, the intensity of the surface waves may get weak. The surface waves generated in the antenna pattern 52 may weaken the transmission and/or reception function of the antenna pattern. For example, the polarization may be linear polarization.

According to an embodiment, the antenna 50 may include at least one dummy pattern 53 so as to suppress the generation of surface waves. According to an embodiment, the antenna 50 may include the antenna member 51, the antenna pattern 52, the at least one dummy pattern 53, and a feed line (e.g., feed pattern) 520. According to an embodiment, the antenna member 51 may have a mesh shape and, for example, a mesh structure may be an array of any one of a square, rhombus, or hexagonal shape.

According to an embodiment, the at least one antenna pattern 52 formed on the antenna member 51 may be a patch antenna, and may be fed by the feed line 520. For example, the antenna pattern 52 may have various shapes including any one of a rectangular, square, or circular shape.

According to an embodiment, the antenna pattern 52 may be electrically connected to a non-shown wireless communication circuit by the feed line 520, and receive a signal.

According to an embodiment, the at least one dummy pattern 53 may be formed on the antenna member 51, in an approximately similar or different shape from the antenna pattern 52. According to an embodiment, the dummy pattern 53 may implement various patch shapes like the antenna pattern 52. According to an embodiment, the dummy pattern 53 may be a conductive pattern having the function of reducing the propagation of surface waves (e.g., suppressing surface waves) generated from the antenna pattern 52, and may be arranged to be spaced apart at each of both sides (e.g., direction perpendicular to polarization of signal radiated from antenna) of the antenna pattern 52.

According to an embodiment, the dummy pattern 53 may be configured to have the same or similar resonance frequency characteristics as the antenna pattern 52 at a distance of half wavelength in a direction perpendicular to the polarization of a signal radiated from the antenna pattern 52. According to an embodiment, the dummy pattern 53 may reduce surface waves by absorbing the surface waves.

According to an embodiment, the dummy pattern 53 may have a similar resonance characteristic to the antenna pattern 52, and may have a grounded structure or an ungrounded structure. FIG. 6 illustrates an insulated structure in which the dummy pattern 53 is not grounded to a ground pattern portion (G). This dummy pattern may be formed as a floating dummy pattern.

According to an embodiment, the dummy pattern 53 may be formed as a pattern that is similar to or different from the antenna pattern 52. For example, the dummy pattern 53 may be a line pattern, and may be formed in a square line pattern shape or rectangular line pattern shape, but is not limited to this structure and may be formed in various shapes.

According to an embodiment, the at least one dummy pattern 53 may be arranged symmetrically at each of both sides of the antenna pattern 52 and spaced apart in a direction perpendicular to the polarization of a signal radiated from the antenna pattern 52. For example, a plurality of dummy patterns 53 may be arranged in the direction perpendicular to the polarization of the signal radiated from the antenna pattern 52.

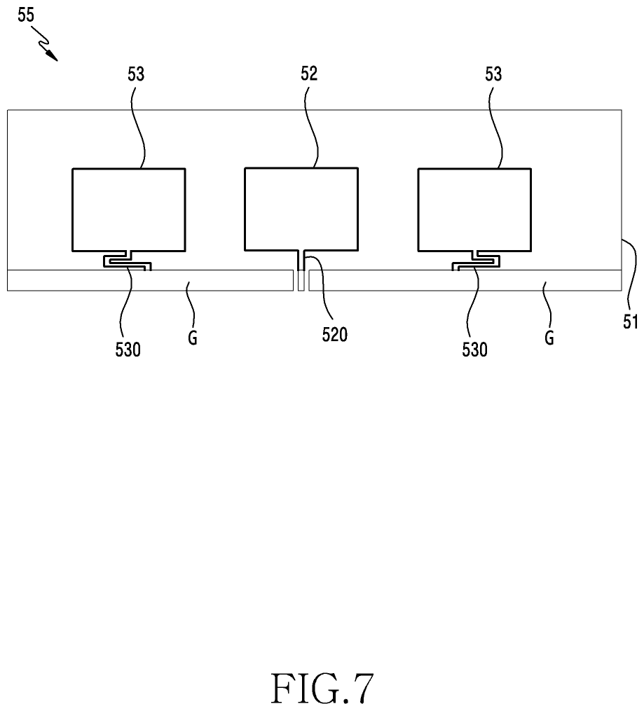

Referring to FIG. 7, according to an embodiment, a detailed description of substantially the same structure of an antenna 55 as the antenna 50 structure illustrated in FIG. 6 may not be repeated here, and only a different structure will be described.

According to an embodiment, the antenna 55 may be formed to be able to adjust the length of a ground line 530 through which a dummy pattern 53 is electrically connected to a ground pattern portion (G). According to an embodiment, the dummy pattern 53 may adjust the length of the ground line 530 and adjust the phase of a resonant frequency of the dummy pattern 53.

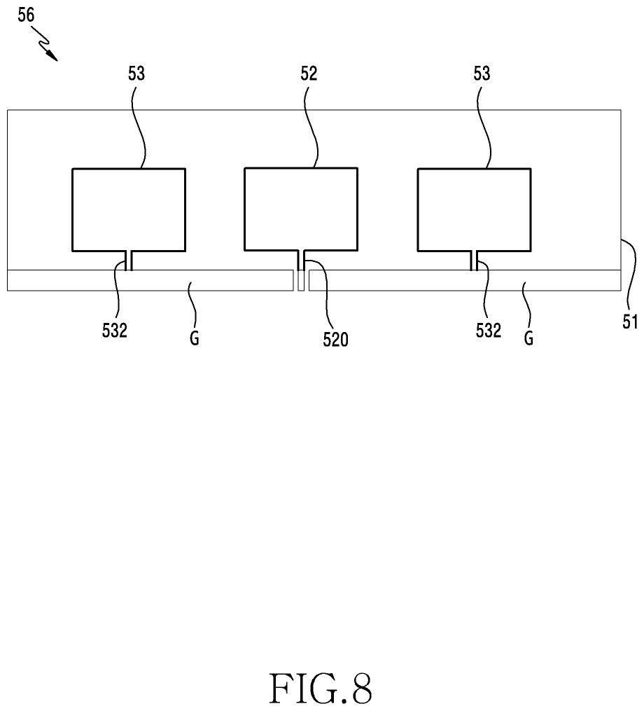

Referring to FIG. 8, according to an embodiment, a detailed description of substantially the same structure of an antenna 56 as the antenna 50 structure illustrated in FIG. 6 may not be repeated here, and only a different structure will be described.

According to an embodiment, the antenna 56 may be arranged in a shorted structure in which a dummy pattern 53 is electrically connected to a ground pattern portion (G) by a ground line 532.

According to an embodiment, when the dummy pattern 53 is electrically connected to the ground pattern portion (G) by the ground line 532, surface waves absorbed may be transferred to the ground pattern portion (G), thereby increasing a surface wave reduction rate.

According to an embodiment, the dummy pattern 53 plays a role in absorbing surface waves generated from the antenna pattern 52, but there may also be a component that re-radiates the absorbed surface waves. The function of this dummy pattern 53 is to adjust the length of the ground line 532 and adjust the phase of the re-radiating component, whereby it is possible to partially adjust the influence of the re-radiating component on a radiation pattern of the antenna.

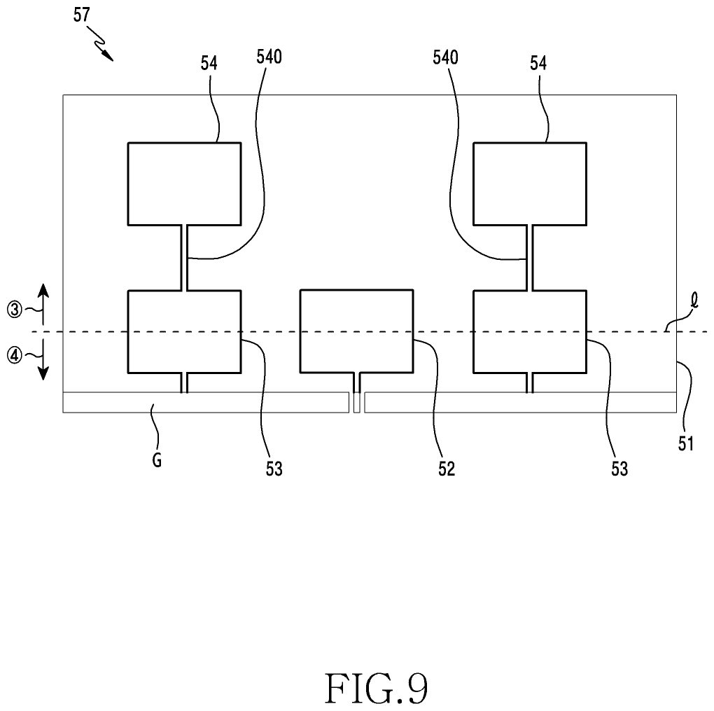

Referring to FIG. 9, according to an embodiment, a detailed description of substantially the same structure of an antenna 57 as the antenna 56 structure illustrated in FIG. 8 may not be repeated here, and only a different structure will be described. Reference symbol I may indicate a horizontal alignment line passing through the center of an antenna pattern 52, reference symbol \textcircled{3} may indicate an upward direction, and reference symbol \textcircled{4} may indicate a downward direction.

Referring to FIG. 9, according to an embodiment, a dummy pattern 54 may be additionally arranged in the antenna 57. According to an embodiment, in the antenna 57, the dummy pattern 54 may be additionally formed above a dummy pattern 53 in a polarization direction (e.g., upward direction and arrow direction (\textcircled{3})) of the antenna pattern 52. The additional dummy pattern 54 of an embodiment may be a conductive pattern and may be arranged in a structure that is electrically connected to the dummy pattern 53 through a connection line 540 on an antenna member 51. According to an embodiment, the additional dummy pattern 54 may be arranged in substantially the same shape as the dummy pattern 53, or may be arranged in a different shape. FIG. 9 illustrates an embodiment in which the additional dummy pattern 54 is arranged in a similar shape to the dummy pattern 53.

According to an embodiment, the additional dummy pattern 54 may be electrically connected to the dummy pattern 53 by the connection line 540, and may be arranged in a grounded structure electrically connected to a ground pattern portion (G).

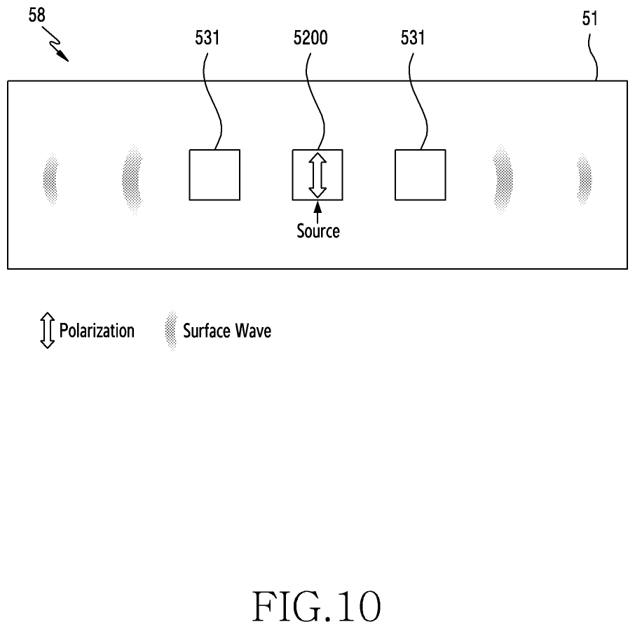

Referring to FIG. 10, according to an embodiment, a detailed description of substantially the same structure of an antenna 58 as the antenna 50 structure illustrated in FIG. 6 may not be repeated here, and only a different structure (e.g., pattern shape) will be described.

According to an embodiment, the antenna 58 may be a single pole antenna, and may include an antenna pattern 5200 arranged on an antenna member 51, and a dummy pattern 531 arranged to be spaced apart from the antenna pattern 5200 in a direction perpendicular to the polarization of the antenna pattern 5200. According to an embodiment, the antenna pattern 5200 may be of a patch type, and may be formed as a rectangular pattern, but is not limited to this structure and may be arranged in various area shapes.

Referring to FIG. 10, surface waves may be formed in a direction perpendicular to a polarization direction of a signal radiated from the antenna pattern 5200, and the surface waves may be reduced as a distance from the antenna pattern 5200 increases. Therefore, the dummy pattern 531 capable of absorbing the surface waves may be arranged in a direction in which the surface waves travel.

According to an embodiment, the dummy pattern 531 may be of a patch type, and may be formed as a rectangular pattern. According to an embodiment, the dummy pattern 531 may be of the patch type, and does not need to be limited to a rectangular pattern structure and may be arranged in various area shapes.

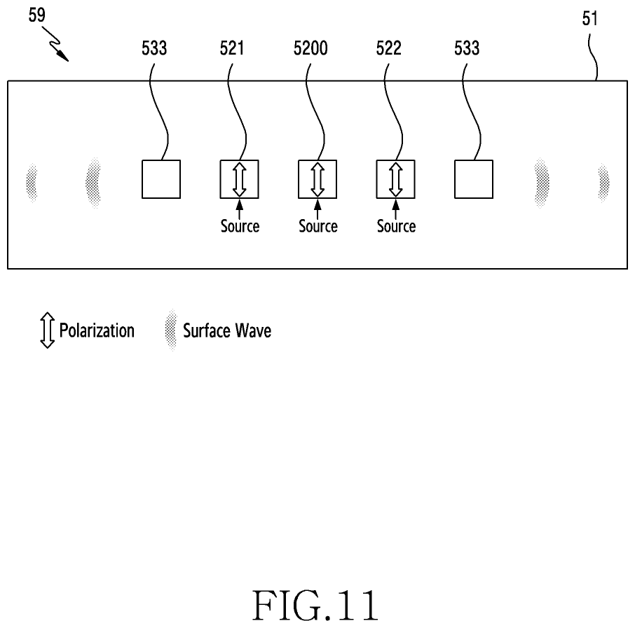

Referring to FIG. 11, according to an embodiment, a detailed description of substantially the same structure of an antenna 59 as the antenna 58 structure illustrated in FIG. 10 may not be repeated here, and only a different structure (e.g., number of antenna patterns) will be described.

According to an embodiment, the antenna 59 may be an antenna array or array antenna that injects the same signal to a plurality of antennas. According to an embodiment, the antenna 59 may have a plurality of antenna patterns 521 and 522 arranged in a direction perpendicular to the polarization of a first antenna pattern 5200 on an antenna member 51. For example, the antenna 59 may include the first antenna pattern 5200, the second antenna pattern 521, and the third antenna pattern 522. For example, the first antenna pattern 5200, the second antenna pattern 521, and the third antenna pattern 522 may be arranged at substantially the same interval. According to an embodiment, each of dummy patterns 533 may be arranged in a direction perpendicular to the polarization of the first antenna pattern 5200, the second antenna pattern 521, and the third antenna pattern 522.

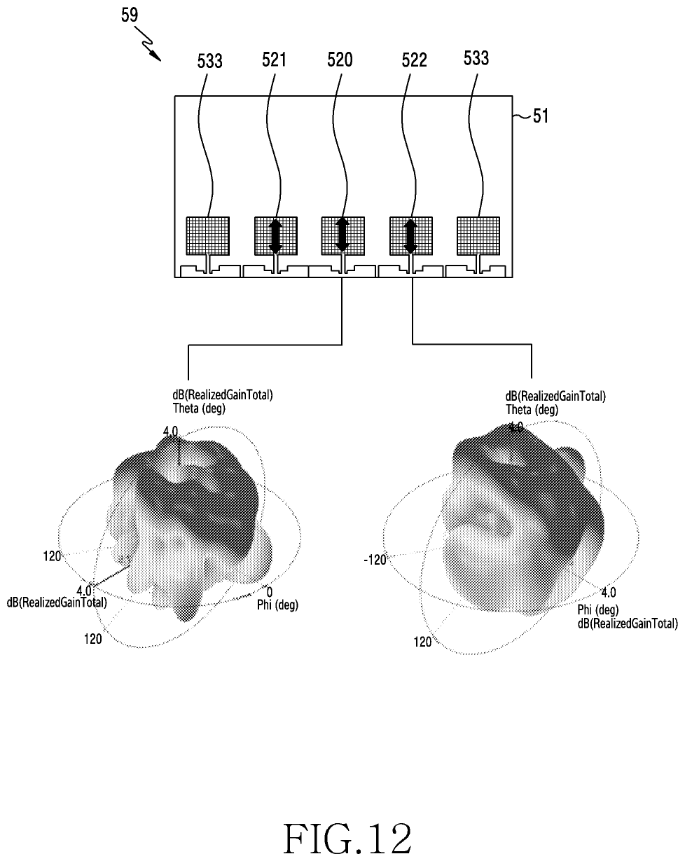

Referring to FIG. 12, according to an embodiment, when the first antenna pattern 520, the second antenna pattern 521, and the third antenna pattern 522 are arranged, the first antenna pattern 520 exhibits relatively left-to-right even pattern characteristics, but the second antenna pattern 521 and third antenna pattern 522 one-sided and biased in arrangement may decrease a beam width and exhibit asymmetrical radiation pattern characteristics due to a re-radiating component of the dummy pattern 533. The antenna having the plurality of antenna patterns may not address the distortion and asymmetry of a radiation pattern with only a simple dummy pattern array.

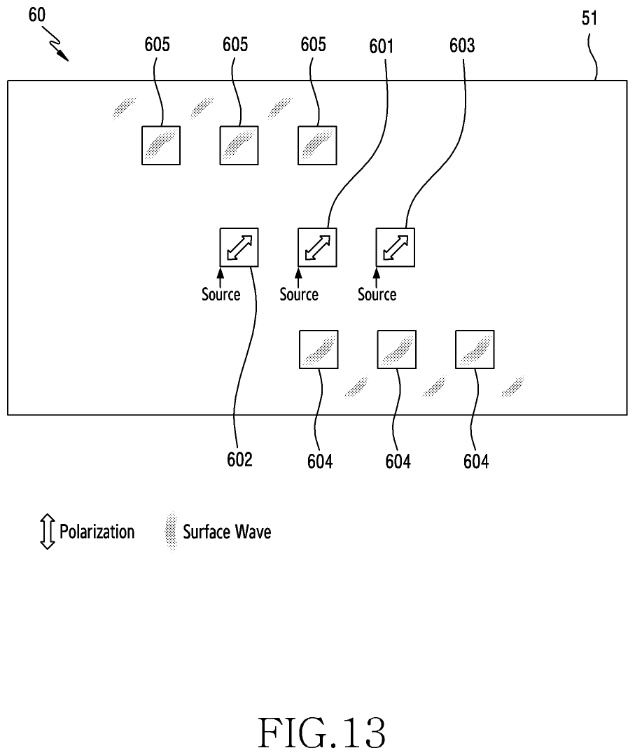

Referring to FIG. 13, according to an embodiment, when the polarization (e.g., diagonal polarization) of a first antenna pattern 601, a second antenna pattern 602, and a third antenna pattern 603 is slanted at 45 degrees, surface waves generated from the first antenna pattern 601, second antenna pattern 602, and third antenna pattern 603 may also change to 45 degrees and proceed.

According to an embodiment, when a first dummy pattern 604 and a second dummy pattern 605 are arranged in directions perpendicular to the polarization of each of the first antenna pattern 601, the second antenna pattern 602, and the third antenna pattern 603 whose polarization is slanted at 45 degrees, surface waves generated from the first antenna pattern 601, the second antenna pattern 602, and the third antenna pattern 603 may be reduced. For example, the number of the first dummy patterns 604 and the second dummy patterns 605 may be determined based on the number of the antenna patterns.

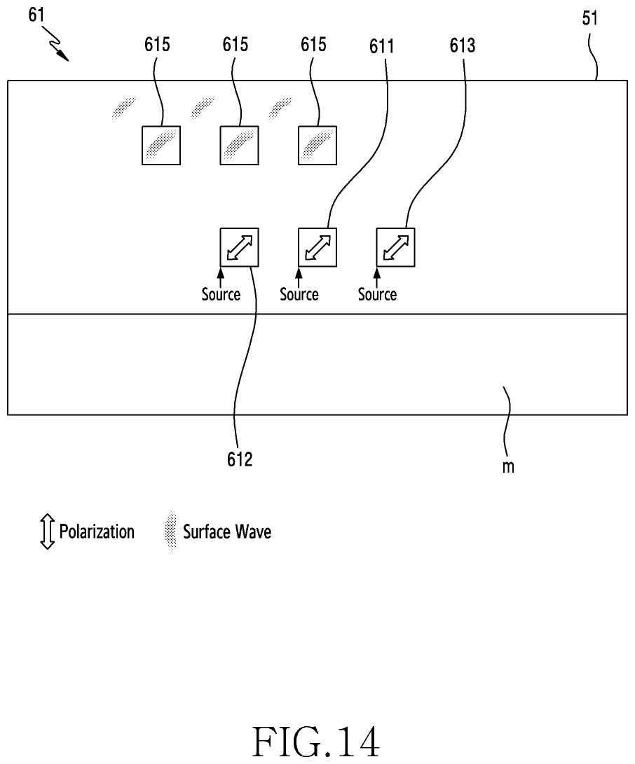

Referring to FIG. 14, a detailed description of substantially the same structure of an antenna 61 of an embodiment as the antenna 60 structure illustrated in FIG. 13 may not be repeated here, and only a different structure will be described.

According to an embodiment, when a first antenna pattern 611, a second antenna pattern 612, and a third antenna pattern 613 whose polarization is slanted at 45 degrees are formed, dummy patterns 615 may be formed corresponding to the first antenna pattern 611, the second antenna pattern 612, and the third antenna pattern 613 at one side of a direction perpendicular to the polarization, and a ground pattern portion (m), for example, a component (e.g., side-surface member) of a metal material may be arranged at the other side of the direction perpendicular to the polarization, thereby suppressing surface waves. According to an embodiment, the ground pattern portion (m) of the metal material may be arranged in a position spaced apart and opposite to the dummy patterns 615 in a polarization direction of the first antenna pattern 611, the second antenna pattern 612, and the third antenna pattern 613.

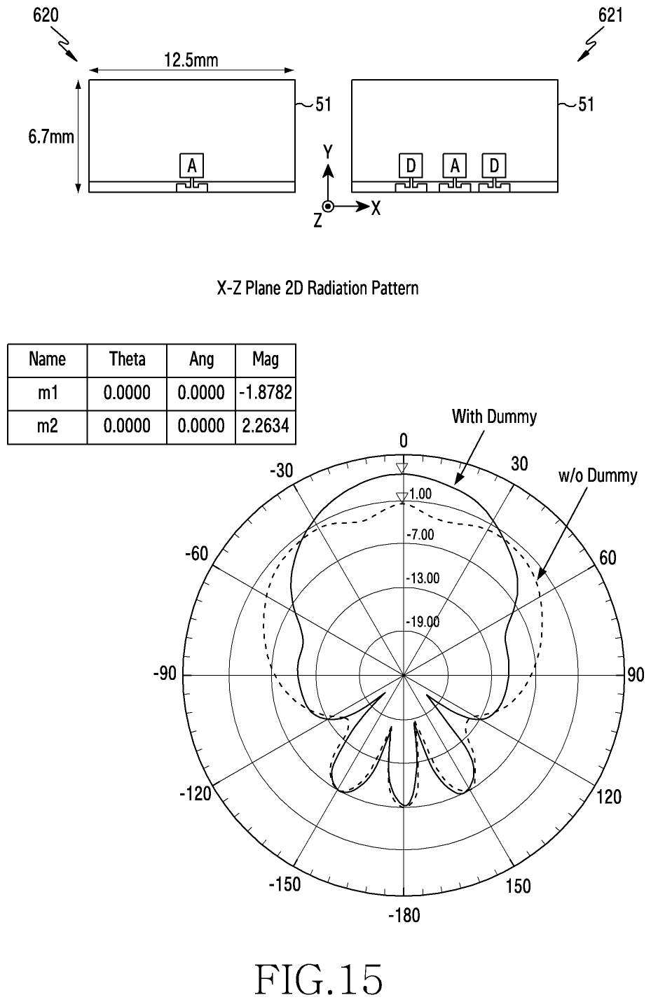

Referring to FIG. 15, an antenna of an embodiment may include a single antenna pattern (A) (e.g., antenna pattern 52 of FIG. 8) on an antenna member 51, and may have a different antenna directivity depending on whether a dummy pattern (D) (e.g., dummy pattern 53 of FIG. 8) exists in a direction perpendicular to the polarization of the single antenna pattern (A).

According to an embodiment, when comparing the antenna 620 having only the single antenna pattern (A) formed on the antenna member 51 having a size of about 12.5 mm in width and about 6.7 mm in height with the antenna 621 having the single antenna pattern (A) and the dummy pattern (D) formed, it may be seen that the directivity of the antenna pattern (A) provided with the dummy pattern (D) is improved.

This result may contribute to the improvement of the radiation performance of the single antenna pattern (A) as the dummy pattern (D) absorbs surface waves generated from the single antenna pattern (A).

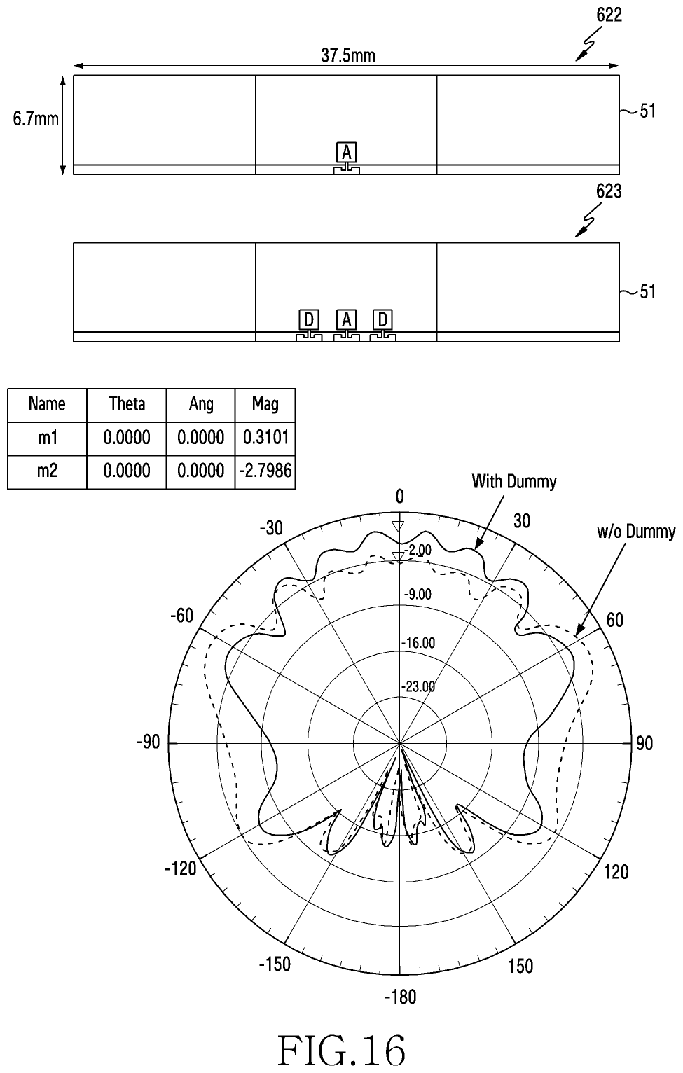

Referring to FIG. 16, an antenna of an embodiment may include a single antenna pattern (A) (e.g., antenna pattern 52 of FIG. 8), and may have a different antenna directivity depending on whether a dummy pattern (D) (e.g., dummy pattern 53 of FIG. 8) exists in a direction perpendicular to the polarization of the single antenna pattern (A).

According to an embodiment, when comparing the antenna 622 having only the single antenna pattern (A) formed on an antenna member 51 having a size of about 37.5 mm in width and about 6.7 mm in height with the antenna 623 having the single antenna pattern (A) and the dummy pattern (D) formed, it may be seen that the directivity of the antenna pattern (A) provided with the dummy pattern (D) is improved. This result may contribute to the improvement of the radiation performance of the single antenna pattern (A) as the dummy pattern (D) absorbs surface waves generated from the single antenna pattern (A).

Referring to FIGS. 15 and 16, it may be seen that the antenna has a gain of about 3 to 4 decibels in a main directional direction, which is improved by the dummy pattern (D) provided for the single antenna pattern (A), regardless of the size of the antenna member 51 (or size of display panel 453). For example, the antenna member 51 may be formed to have substantially the same size as the display panel 453.

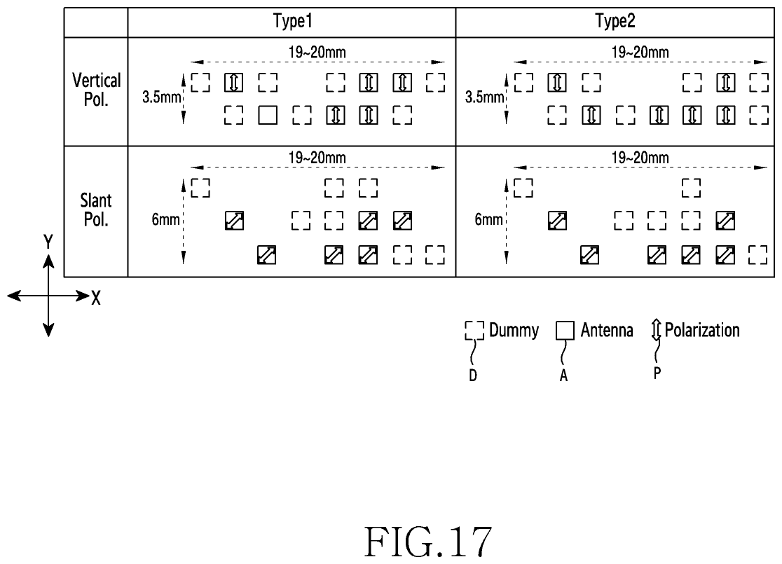

Referring to FIG. 17, an antenna of an embodiment may have at least one dummy pattern (D) arranged in various types in a direction perpendicular to the polarization (P) of an antenna pattern (A). In FIG. 17, the orthogonal coordinate system may be used, and the X-axis may refer to a horizontal direction (e.g., left-right direction) and the Y-axis may refer to a vertical direction (e.g., up-down direction).

According to an embodiment, when the antenna pattern (A) generates polarization (P) in the up-down direction (e.g., Y-axis direction), the dummy pattern (D) may be arranged in the direction perpendicular to the polarization (P), for example, in the horizontal direction (e.g., X-axis direction).

According to an embodiment, when the antenna pattern (A) generates polarization (P) (e.g., diagonal polarization) in a direction slanted at 45 degrees, the dummy pattern (D) may be arranged to correspond to the antenna pattern (A) in a direction perpendicular to the polarization (P) slanted at 45 degrees.

These various antenna patterns (A) and dummy patterns (D) may be arranged in various types.

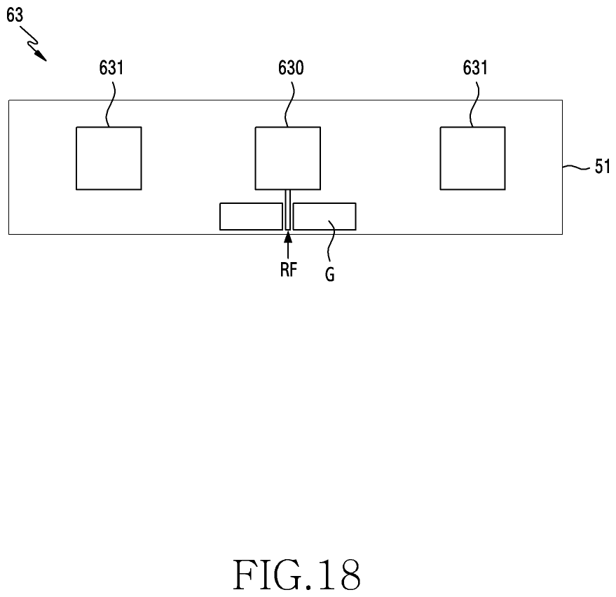

Referring to FIG. 18, according to an embodiment, a detailed description of substantially the same structure of an antenna 63 as the antenna 50 structure illustrated in FIG. 6 may not be repeated here, and only a different structure (e.g., pattern shape) will be described.

According to an embodiment, an antenna 63 may be a single pole/single antenna, and may include an antenna pattern 630 disposed on an antenna member 51, or a dummy pattern 631 arranged to be spaced apart in a direction perpendicular to the polarization of a signal radiated from the antenna pattern 630. According to an embodiment, the antenna pattern 630 may be formed in a polygonal patch type. However, the area of the antenna pattern does not need to be limited to a rectangular area pattern structure and may be arranged in various area shapes.

According to an embodiment, the dummy pattern 631 may be arranged to be spaced apart in the direction perpendicular to the polarization of the antenna pattern 630.

According to an embodiment, the dummy pattern 631 may be of a polygonal patch type and may be formed as a rectangular area pattern. According to an embodiment, the dummy pattern 631 may be of a rectangular patch type and may be formed in a shape identical to or similar to that of the antenna pattern. However, the shape of the dummy pattern 631 does not need to be limited to a rectangular area pattern structure and may be arranged in various area shapes.

According to an embodiment, the dummy pattern 631 may be formed as a floating dummy pattern that is not electrically connected to a ground pattern portion (G).

According to an embodiment, the ground pattern portion (G) may not be formed in an area corresponding to the dummy pattern 631, but may be formed only in an area corresponding to the antenna pattern 630.

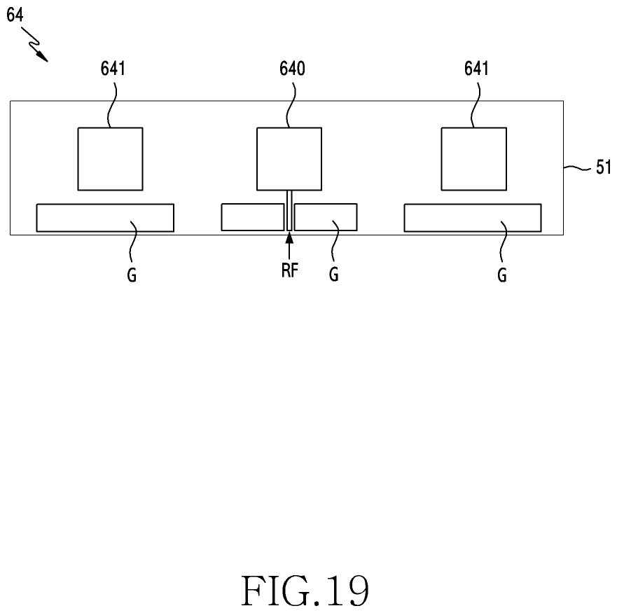

Referring to FIG. 19, according to an embodiment, a detailed description of substantially the same structure of an antenna 64 as the antenna 63 structure illustrated in FIG. 18 may not be repeated here, and only a different structure (e.g., dummy pattern arrangement) will be described.

According to an embodiment, an electronic device including the antenna 64 may include a ground pattern portion (G). According to an embodiment, the ground pattern portion (G) may be also formed in an area corresponding to a dummy pattern 641.

According to an embodiment, the dummy pattern 641 may be formed as a floating dummy pattern.

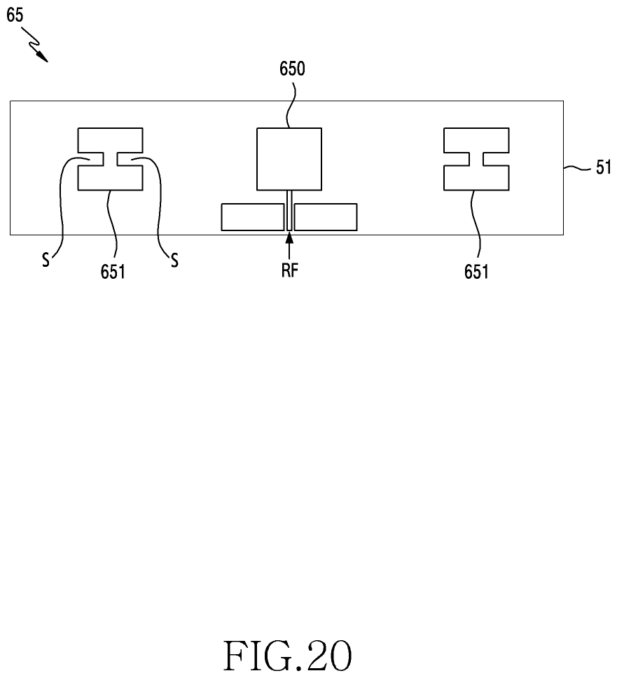

Referring to FIG. 20, according to an embodiment, a detailed description of substantially the same structure of an antenna 65 as the antenna 63 structure illustrated in FIG. 18 may not be repeated here, and only a different structure (e.g., dummy pattern shape) will be described.

According to an embodiment, a dummy pattern 651 may be of a roughly rectangular pattern shape, and may be of a pattern shape in which a pair of slits(s) extending in a direction perpendicular to the polarization of an antenna pattern 650 are formed. For example, the dummy pattern 651 may be of an English alphabet H shape that is laid down in the direction perpendicular to the polarization of the antenna pattern 650.

According to an embodiment, the dummy pattern 651 may be formed as a floating dummy pattern.

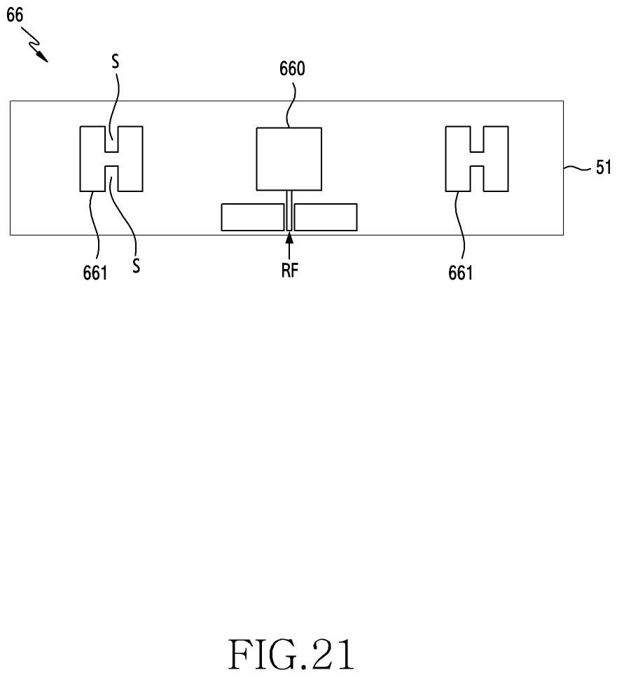

Referring to FIG. 21, according to an embodiment, a detailed description of substantially the same structure of an antenna 66 as the antenna 65 structure illustrated in FIG. 20 may not be repeated here, and only a different structure (e.g., dummy pattern shape) will be described.

According to an embodiment, a dummy pattern 661 may be of a substantially rectangular area pattern shape, and may be of a pattern shape in which a pair of slits(s) extending in a polarization direction of the antenna pattern 660 are formed. For example, the dummy pattern 661 may be of an English alphabet H shape.

According to an embodiment, the dummy pattern 661 may be formed as a floating dummy pattern.

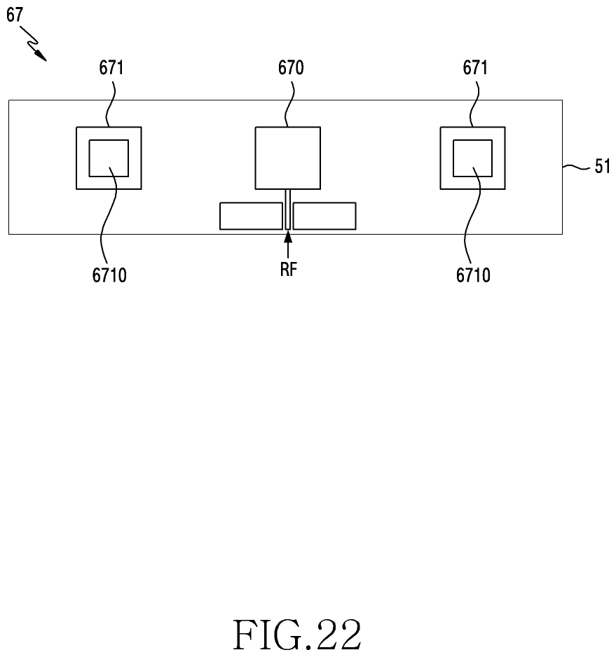

Referring to FIG. 22, according to an embodiment, a detailed description of substantially the same structure of an antenna 67 as the antenna 63 structure illustrated in FIG. 18 may not be repeated here, and only a different structure (e.g., dummy pattern shape) will be described.

According to an embodiment, a dummy pattern 671 may be of a pattern shape similar to the dummy pattern 53 illustrated in FIG. 6, and may be a pattern having an empty internal space. The dummy pattern 671 of an embodiment may be of a pattern shape having an opening 6710 formed in the center of the internal space.

According to an embodiment, the dummy pattern 671 may be formed as a floating dummy pattern.

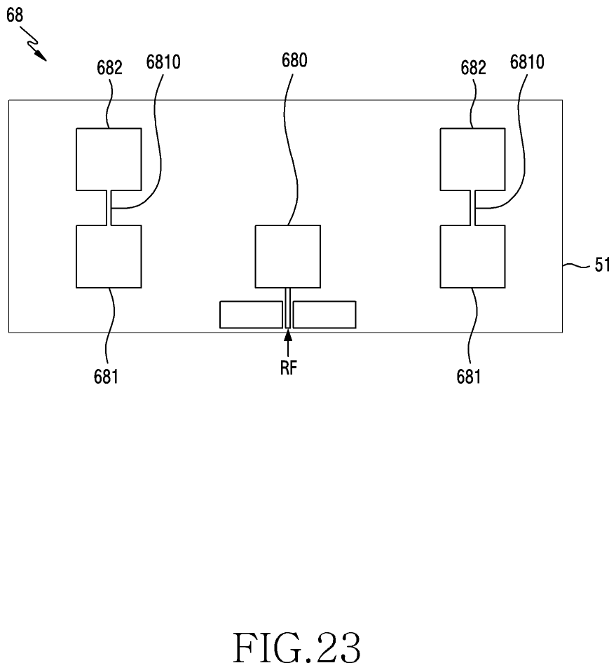

Referring to FIG. 23, according to an embodiment, a detailed description of substantially the same structure of an antenna 68 as the antenna 63 structure illustrated in FIG. 18 may not be repeated here, and only a different structure (e.g., addition of dummy pattern) will be described.

According to an embodiment, the antenna 68 may have an additional dummy pattern 682 arranged above a dummy pattern 681 in a polarization direction of an antenna pattern 680. According to an embodiment, the additional dummy pattern 682 may be a conductive pattern substantially identical to or similar to the dummy pattern 681, and may absorb part of surface waves spreading in a direction perpendicular to the polarization of the antenna pattern 680 and help to prevent and/or reduce the deterioration of a radiation capability of the antenna pattern 680.

According to an embodiment, the additional dummy pattern 682 may be electrically connected to the dummy pattern 681 by a connection line 6810. According to an embodiment, the connection line 6810 may be of a straight line shape and may be of a shape of extending in a direction parallel to a polarization direction (e.g., vertical direction) of the antenna pattern 680. According to an embodiment, the dummy pattern 681 and the additional dummy pattern 682 may be formed as floating dummy patterns.

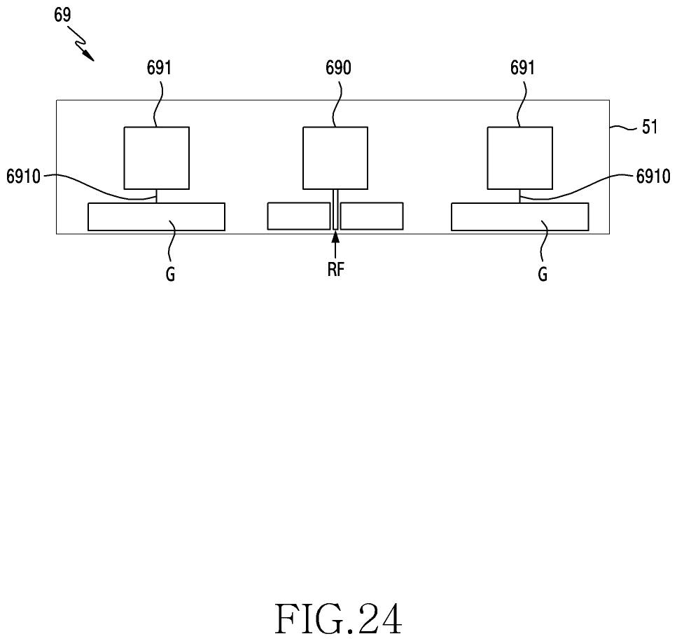

Referring to FIG. 24, according to an embodiment, a detailed description of substantially the same structure of an antenna 69 as the antenna 63 structure illustrated in FIG. 18 and FIG. 19 may not be repeated here, and only a different structure (e.g., addition of ground pattern portion (G)) will be described.

According to an embodiment, the antenna 69 may have a dummy pattern 691 electrically connected to a ground pattern portion (G) through a ground line 6910. According to an embodiment, the antenna 69 may have a similar structure to the antenna 56 illustrated in FIG. 8.

According to an embodiment, the antenna 69 may be arranged in a shorted structure in which the dummy pattern 691 is electrically connected to the ground pattern portion (G) by the ground line 6910. For example, the dummy pattern 691 may be arranged symmetrically centering on an antenna pattern 690.

According to an embodiment, when the dummy pattern 691 is electrically connected to the ground pattern portion (G) by the ground line 6910, surface waves absorbed by the dummy pattern 691 may be transferred to the ground pattern portion (G), thereby increasing a surface wave reduction rate.

According to an embodiment, the dummy pattern 691 plays a role in absorbing surface waves generated from the antenna pattern 690, but there may also be a component that re-radiates the absorbed surface waves. The function of this dummy pattern 691 is to adjust the length of the ground line 6910 and adjust the phase of the re-radiating component, whereby it is possible to partially control the influence of the re-radiating component on a radiation pattern of the antenna.

According to an embodiment, the dummy pattern 691 may be formed as a dummy pattern shorted from the ground pattern portion (G).

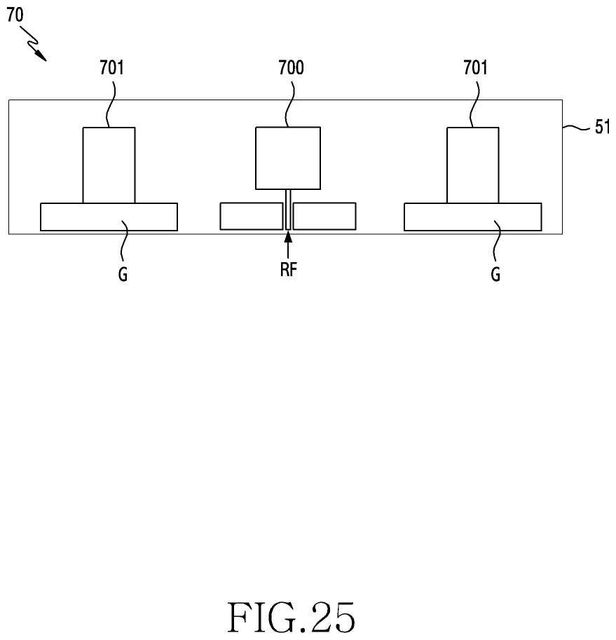

Referring to FIG. 25, according to an embodiment, a detailed description of substantially the same structure of an antenna 70 as the antenna 69 structure illustrated in FIG. 24 may not be repeated here, and only a different structure (e.g., ground pattern portion) will be described.

According to an embodiment, the antenna 70 may have a dummy pattern 701 that is not of the same or similar pattern shape to an antenna pattern 700 and is arranged in a direction perpendicular to the polarization of the antenna pattern 700. For example, the dummy pattern 701 may be a rectangular area pattern and may be arranged in a short-circuited state in which the dummy pattern 701 is directly electrically connected to the ground pattern portion (G). For example, the dummy pattern 701 may be arranged symmetrically centering on the antenna pattern 700.

According to an embodiment, when the dummy pattern 701 is directly electrically connected to the ground pattern portion (G), surface waves absorbed by the dummy pattern 701 may be transferred to the ground pattern portion (G), thereby increasing a surface wave reduction rate.

According to an embodiment, the dummy pattern 701 may be formed as a dummy pattern shorted from the ground pattern portion (G).

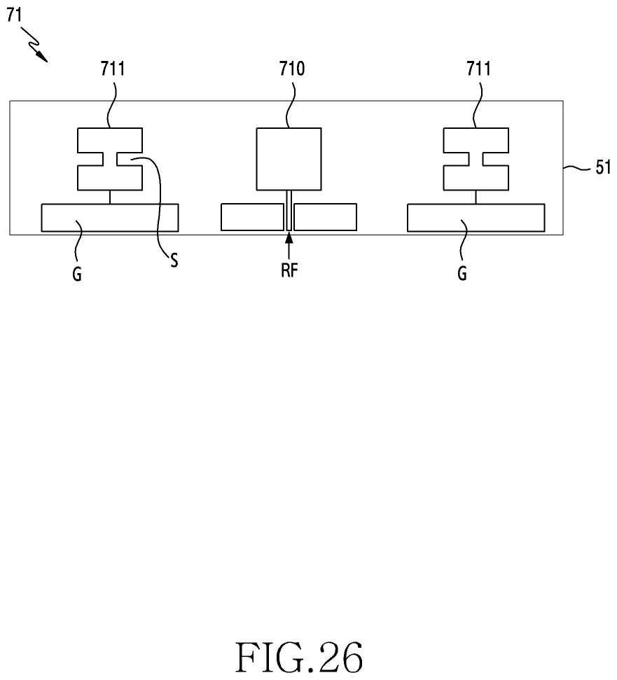

Referring to FIG. 26, according to an embodiment, a detailed description of substantially the same structure of an antenna 71 as the antenna 69 structure illustrated in FIG. 24 may not be repeated here, and only a different structure (e.g., dummy pattern shape) will be described.

According to an embodiment, a dummy pattern 711 may be an approximately square area pattern and may be of a pattern shape in which a pair of slits(s) extending in a direction perpendicular to the polarization of an antenna pattern 710 are formed. For example, the dummy pattern 711 may be of an English alphabet H shape that is laid down. For example, the dummy pattern 711 may be arranged symmetrically centering on the antenna pattern 710.

According to an embodiment, the dummy pattern 711 may be formed as a dummy pattern shorted from the ground pattern portion (G).

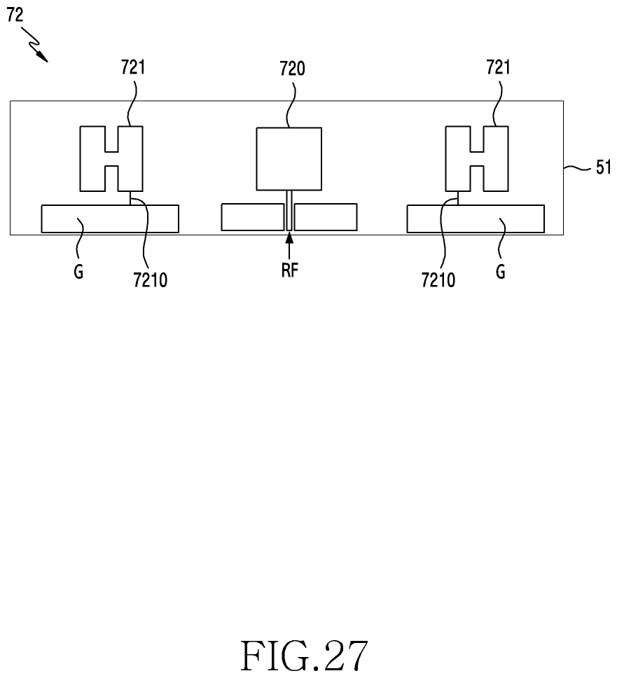

Referring to FIG. 27, according to an embodiment, a detailed description of substantially the same structure of an antenna 72 as the antenna 69 structure illustrated in FIG. 24 may not be repeated here, and only a different structure (e.g., dummy pattern shape) will be described.

According to an embodiment, a dummy pattern 721 may be of an approximately square area pattern shape and may be of a pattern shape in which a pair of slits(s) extending in a polarization direction of an antenna pattern 720 are formed. For example, the dummy pattern 721 may be of an English alphabet H shape. For example, the dummy pattern 721 may be arranged symmetrically centering on the antenna pattern 720.

According to an embodiment, when the dummy pattern 721 is electrically connected to the ground pattern portion (G) by a ground line 7210, surface waves absorbed by the dummy pattern 721 may be transferred to the ground pattern portion (G), thereby increasing a surface wave reduction rate.

According to an embodiment, the dummy pattern 721 may be formed as a dummy pattern shorted from the ground pattern portion (G).

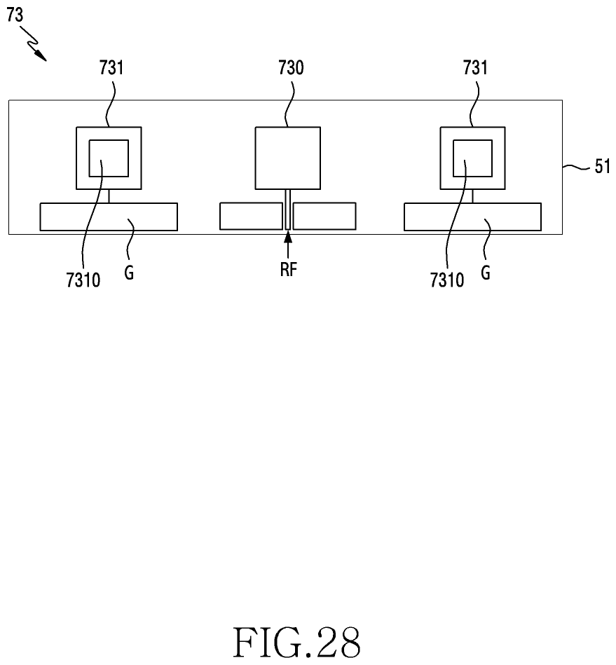

Referring to FIG. 28, according to an embodiment, a detailed description of substantially the same structure of an antenna 73 as the antenna 69 structure illustrated in FIG. 24 may not be repeated here, and only a different structure (e.g., dummy pattern shape) will be described.

According to an embodiment, a dummy pattern 731 may be of a pattern shape similar to that of the dummy pattern 53 illustrated in FIG. 6, and may be a pattern having an empty internal space. The dummy pattern 731 of an embodiment may be of a pattern shape in which an opening 7310 is formed in a center area of the internal space. For example, the opening 7310 may have any one of a square shape or rectangular shape, and is not limited to this shape and may be formed in various shapes.

According to an embodiment, the dummy pattern 731 may be formed as a dummy pattern shorted from the ground pattern portion (G).

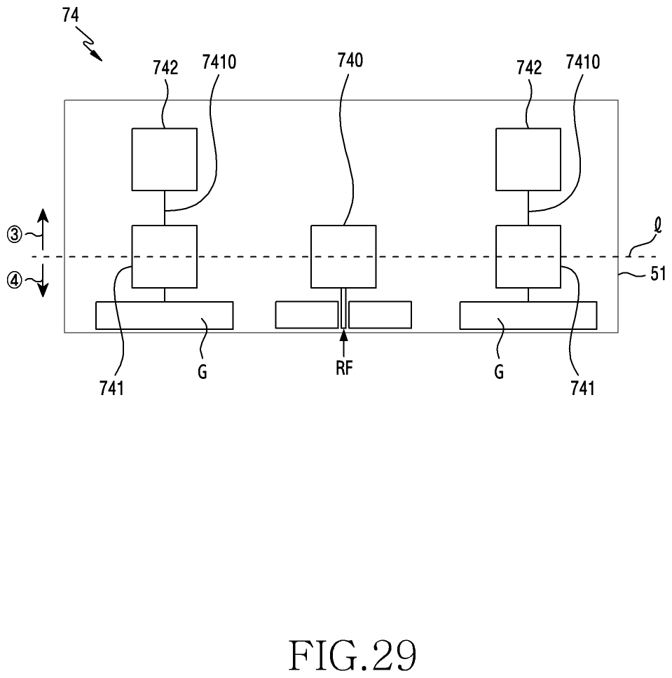

Referring to FIG. 29, according to an embodiment, a detailed description of substantially the same structure of an antenna 74 as the antenna 69 structure illustrated in FIG. 24 may not be repeated here, and only a different structure (e.g., addition of dummy pattern) will be described. Reference symbol I may indicate a horizontal alignment line passing through the center of an antenna pattern 740, reference symbol \textcircled{3} may indicate an upward direction, and reference symbol \textcircled{4} may indicate a downward direction.

According to an embodiment, the antenna 74 may have an additional dummy pattern 742 arranged above a dummy pattern 741 in a polarization direction (e.g., horizontal alignment line (1)) of the antenna pattern 740. According to an embodiment, the additional dummy pattern 742 may be a conductive pattern substantially identical to or similar to the dummy pattern 741 and may absorb part of surface waves spreading in a direction perpendicular to the polarization of the antenna pattern 740 and help to prevent and/or reduce the deterioration of a radiation capability of the antenna pattern 740.

According to an embodiment, the dummy pattern 741 may be arranged in the direction perpendicular to polarization generated from the antenna pattern 740, and the additional dummy pattern 742 may be arranged to be aligned with the dummy pattern 741 in a polarization direction (e.g., upward direction (\textcircled{3})) of the antenna pattern 740.

According to an embodiment, the additional dummy pattern 742 may be electrically connected to the dummy pattern 741 by a connection line 7410. According to an embodiment, the dummy pattern 741 and the additional dummy pattern 742 may be formed as dummy patterns shorted from the ground pattern portion (G).

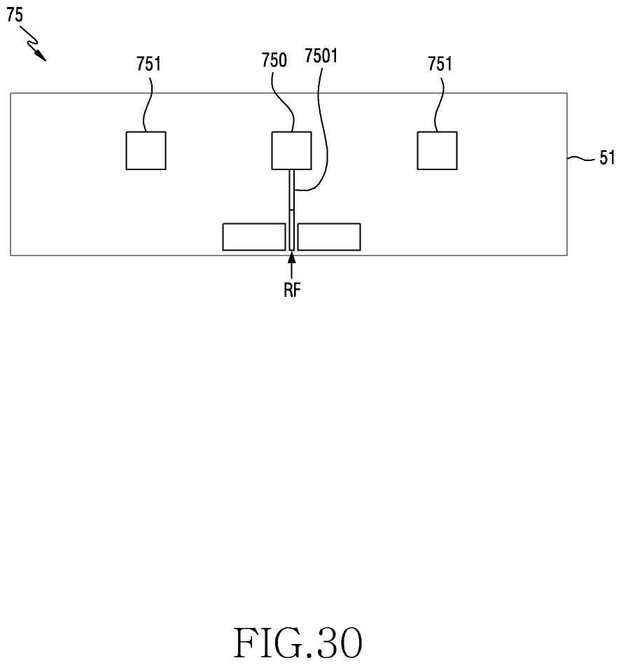

Referring to FIG. 30, according to an embodiment, a detailed description of substantially the same structure of an antenna 75 as the antenna 63 structure illustrated in FIG. 18 may not be repeated here, and only a different structure (e.g., adjustment of length of feed line) will be described.

According to an embodiment, the antenna 75 may include an antenna pattern 750, and a dummy pattern 751 arranged to be aligned with and spaced apart from the antenna pattern 750 in a direction perpendicular to the polarization of the antenna pattern 750. According to an embodiment, the antenna pattern 750 may increase the length of a feed line 7501 compared to FIG. 18, and adjust (e.g., λ/2) the phase of a resonant frequency of the antenna pattern 750.

According to an embodiment, when the dummy pattern 751 is arranged to be spaced apart from the ground pattern portion (G), the dummy pattern 751 may be formed as a floating dummy pattern.

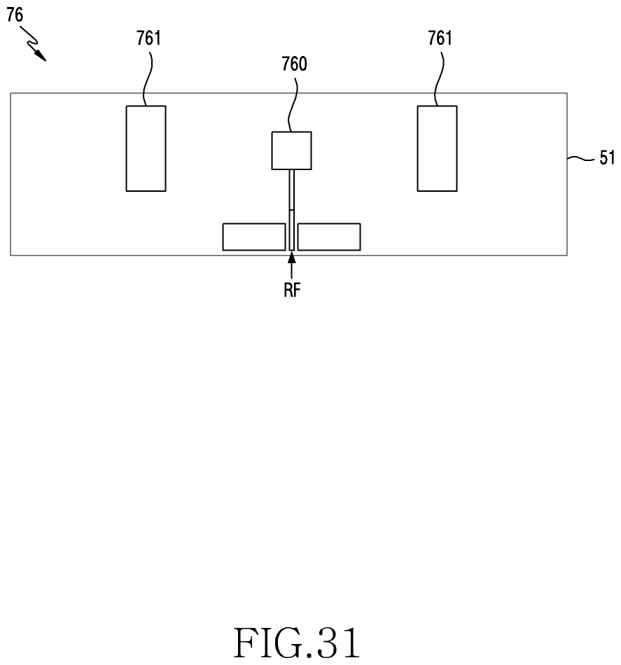

Referring to FIG. 31, according to an embodiment, a detailed description of substantially the same structure of an antenna 76 as the antenna 75 structure illustrated in FIG. 30 may not be repeated here, and only a different structure (e.g., dummy pattern shape) will be described.

According to an embodiment, the antenna 76 may have a dummy pattern 761 having a different shape from an antenna pattern 760, having an increased vertical width, and arranged in a direction perpendicular to the polarization of the antenna pattern 760. According to an embodiment, the dummy pattern 761 may be formed to have a larger vertical width than the dummy pattern 751 illustrated in FIG. 30, and absorb relatively more surface waves spreading in the direction perpendicular to the polarization of the antenna pattern 760. As a result, the dummy pattern 761 may have a larger surface wave reduction rate than the dummy pattern 751.

According to an embodiment, the dummy pattern 761 may be arranged symmetrically centering on the antenna pattern 760.

According to an embodiment, the dummy pattern 761 may be formed as a floating dummy pattern.

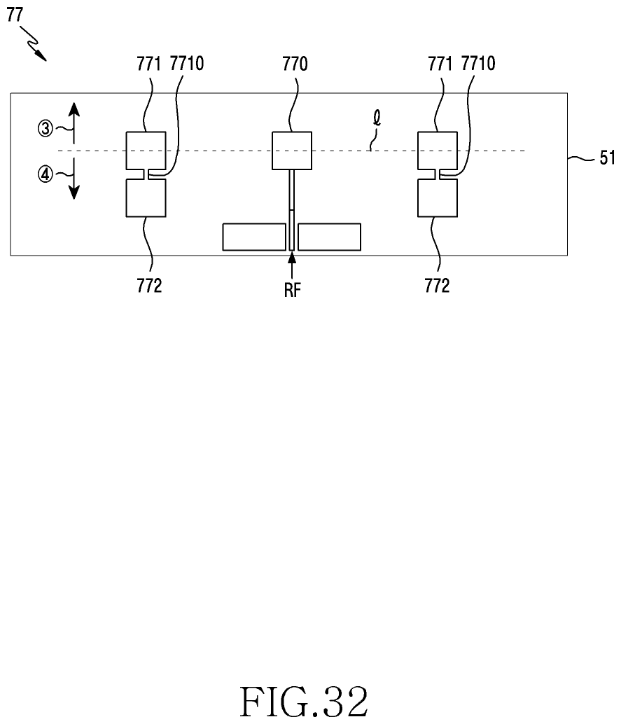

Referring to FIG. 32, according to an embodiment, a detailed description of substantially the same structure of an antenna 77 as the antenna 75 structure illustrated in FIG. 30 may not be repeated here, and only a different structure (e.g., addition of dummy pattern) will be described. Reference symbol 1 may indicate a horizontal alignment line passing through the center of an antenna pattern 770, reference symbol \textcircled{3} may indicate an upward direction, and reference symbol \textcircled{4} may indicate a downward direction.

According to an embodiment, the antenna 77 may have an additional dummy pattern 772 arranged in the downward direction (\textcircled{4}) in a state aligned with a dummy pattern 771 in a polarization direction of the antenna pattern 770. The aligned state may be a state aligned in a horizontal direction or vertical direction, and may refer, for example, to the additional dummy pattern 772 being arranged wherein the dummy pattern 771 is arranged to be aligned with the antenna pattern 770 along the horizontal alignment line (l).

According to an embodiment, the additional dummy pattern 772 may be a conductive pattern identical to or similar to the dummy pattern 771, and may absorb part of surface waves spreading in a direction perpendicular to the polarization of the antenna pattern 770 and prevent or reduce the deterioration of a radiation capability of the antenna pattern 770.

According to an embodiment, the additional dummy pattern 772 may be electrically connected to the dummy pattern 771 by a connection line 7710. According to an embodiment, the additional dummy pattern 772 may be arranged in a direction of one side of the polarization of the antenna pattern 770 from the dummy pattern 771. For example, when the antenna 77 is viewed from the front, the direction of the one side may be the downward direction (\textcircled{4}) of the dummy pattern 771.

According to an embodiment, the dummy pattern 771 and the additional dummy pattern 772 may be formed as floating dummy patterns.

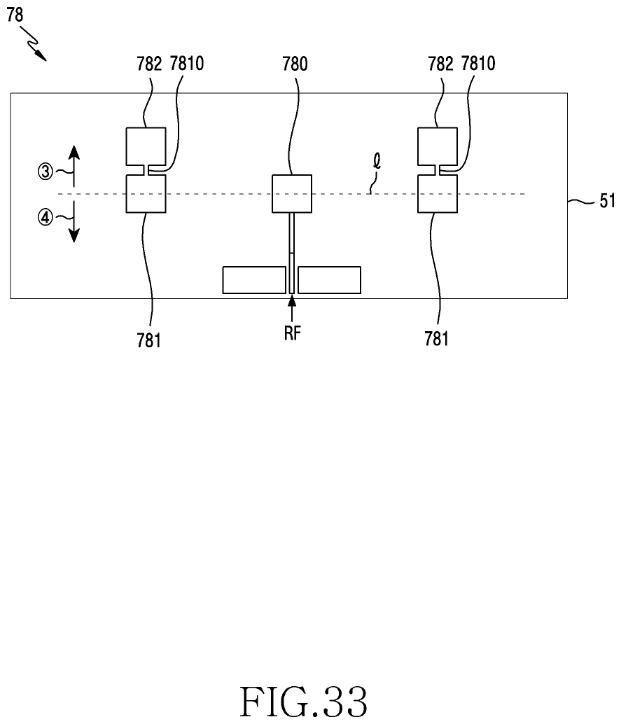

Referring to FIG. 33, according to an embodiment, a detailed description of substantially the same structure of an antenna 78 as the antenna 77 structure illustrated in FIG. 32 may not be repeated here, and only a different structure (e.g., position of additional dummy pattern) will be described. Reference symbol 1 may indicate a horizontal alignment line passing through the center of an antenna pattern 780, reference symbol \textcircled{3} may indicate an upward direction, and reference symbol \textcircled{4} may indicate a downward direction.

According to an embodiment, the antenna 78 may have an additional dummy pattern 782 arranged in a state aligned with a dummy pattern 781 in a polarization direction of the antenna pattern 780. The aligned state may refer, for example, to the dummy pattern 781 being arranged to be aligned with the antenna pattern 780 along the horizontal alignment line (l), and the additional dummy pattern 782 is arranged in a state aligned with the dummy pattern 781 in the polarization direction (e.g., upward direction (\textcircled{3})).

According to an embodiment, the additional dummy pattern 782 may be a conductive pattern identical to or similar to the dummy pattern 781, and may absorb part of surface waves spreading in a direction perpendicular to the polarization of the antenna pattern 780 and prevent or reduce the deterioration of a radiation capability of the antenna pattern 780.

According to an embodiment, the additional dummy pattern 782 may be electrically connected to the dummy pattern 781 by a connection line 7810. According to an embodiment, the additional dummy pattern 782 may be arranged in the upward direction (\textcircled{3}) of the antenna pattern 780 from the dummy pattern 781.

According to an embodiment, the dummy pattern 781 and the additional dummy pattern 782 may be formed as floating dummy patterns.

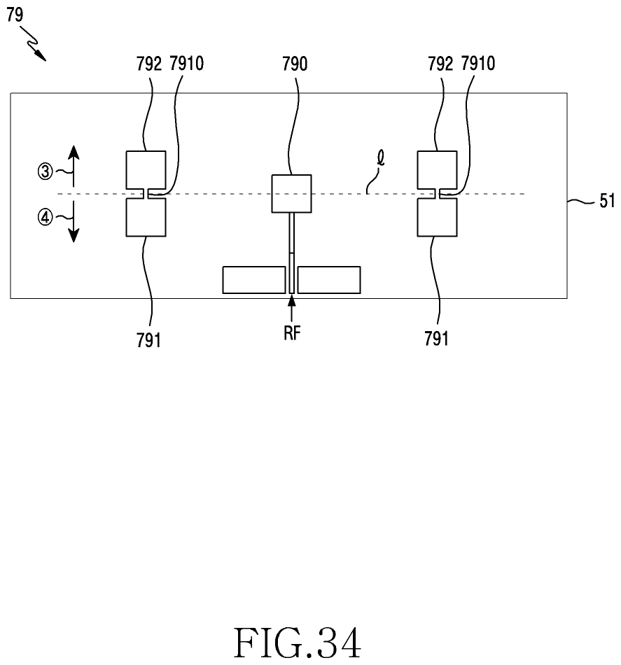

Referring to FIG. 34, according to an embodiment, a detailed description of substantially the same structure of an antenna 79 as the antenna 77 structure illustrated in FIG. 32 may not be repeated here, and only a different structure (e.g., dummy pattern arrangement) will be described. Reference symbol 1 may indicate a horizontal alignment line passing through the center of an antenna pattern 790, reference symbol \textcircled{3} may indicate an upward direction, and reference symbol \textcircled{4} may indicate a downward direction.

According to an embodiment, the antenna 79 may have a dummy pattern

791 and an additional dummy pattern 792 that are arranged in a state non-aligned in a direction perpendicular to the polarization of the antenna pattern 790. The non-aligned state may refer, for example, to the dummy pattern 791 and the additional dummy pattern 792 being arranged to not be aligned with the antenna pattern 780 along the horizontal alignment line (l). In an embodiment, the dummy pattern 791 and the additional dummy pattern 792 may be arranged symmetrically centering on the horizontal alignment line (l). According to an embodiment, the dummy pattern 791 and the additional dummy pattern 792 may be arranged in the downward direction (\textcircled{4}) and the upward direction (\textcircled{3}), based on the horizontal alignment line (1), respectively.

According to an embodiment, the additional dummy pattern 792 may be a conductive pattern identical to or similar to the dummy pattern 791 and may absorb surface waves spreading in the direction perpendicular to the polarization of the antenna pattern 790 and prevent and/or reduce the deterioration of a radiation capability of the antenna pattern 790.

According to an embodiment, the additional dummy pattern 792 may be electrically connected to the dummy pattern 791 by a connection line 7910. According to an embodiment, the connection line 7910 may be arranged in a state aligned in a position spaced apart from the antenna pattern 790 along the horizontal alignment line (l).

According to an embodiment, the dummy pattern 791 and the additional dummy pattern 792 may be formed as floating dummy patterns.

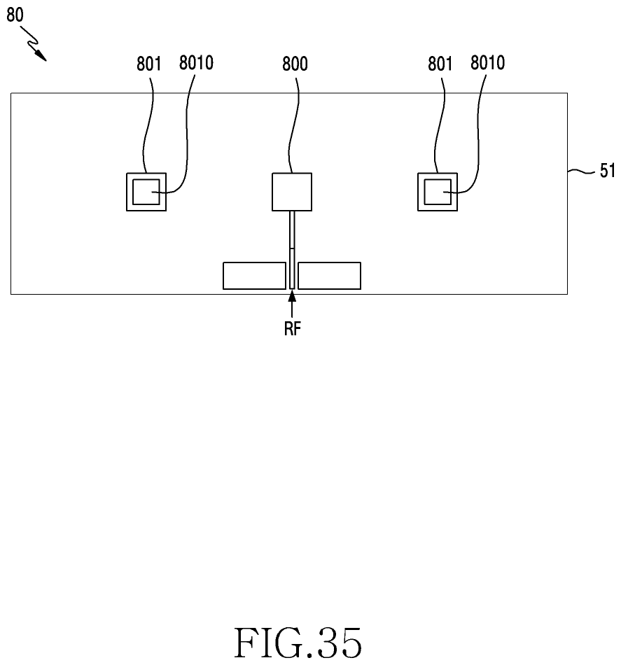

Referring to FIG. 35, according to an embodiment, a detailed description of substantially the same structure of an antenna 80 as the antenna 75 structure illustrated in FIG. 30 may not be repeated here, and only a different structure (e.g., dummy pattern shape) will be described.

According to an embodiment, a dummy pattern 801 may be a conductive pattern having an empty internal space center area and, for example, may be formed as an approximately square or rectangular type pattern. According to an embodiment, the dummy pattern 801 may have an opening 8010 formed in the internal space center area, and the opening 8010 may have any one of a rectangular shape or square shape, but does not need to be limited to such a shape. According to an embodiment, the dummy pattern 801 may be arranged to be spaced apart from the antenna pattern 800 in a state aligned in a direction perpendicular to the polarization of the antenna pattern 800. For example, the dummy pattern 801 may be formed in a shape having a uniform width (e.g., thickness).

According to an embodiment, the dummy pattern 801 may be formed as a floating dummy pattern.

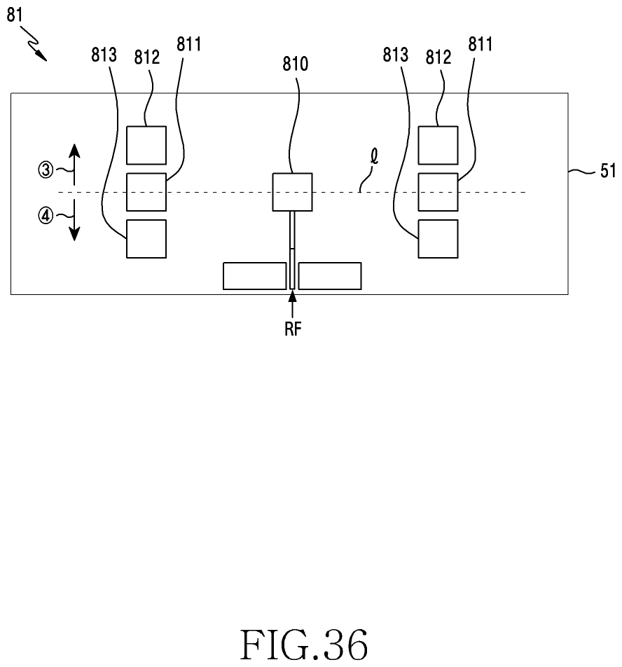

Referring to FIG. 36, according to an embodiment, a detailed description of substantially the same structure of an antenna 81 as the antenna 75 structure illustrated in FIG. 30 may not be repeated here, and only a different structure (e.g., dummy pattern shape) will be described. Reference symbol 1 may indicate a horizontal alignment line passing through the center of an antenna pattern 810, reference symbol \textcircled{3} may indicate an upward direction, and reference symbol \textcircled{4} may indicate a downward direction.

According to an embodiment, the antenna 81 may have a second dummy pattern 812 and a third dummy pattern 813 that are arranged in a state aligned with a first dummy pattern 811 in a polarization direction of the antenna pattern 810. For example, the aligned state may refer, for example, to the first dummy pattern 811, the second dummy pattern 812, and the third dummy pattern 813 being arranged to be aligned based on the horizontal alignment line (l) from the antenna pattern 810.

According to an embodiment, the second dummy pattern 812 and the third dummy pattern 813 may be conductive patterns identical to or similar to the first dummy pattern 811, and may absorb part of surface waves spreading in a direction perpendicular to the polarization of the antenna pattern 810 and prevent or reduce the deterioration of a radiation capability of the antenna pattern 810.

According to an embodiment, the second dummy pattern 812 and the third dummy pattern 813 may be arranged in a state aligned with the first dummy pattern 811 in directions of one side (e.g., upward direction (\textcircled{3})) and the other side (e.g., downward direction (\textcircled{4})) of the polarization of the antenna pattern 810, respectively. For example, when the antenna 81 is viewed from the front, the direction of one side of the polarization of the antenna pattern 810 may be the upward direction (\textcircled{3}) of the first dummy pattern 811, and the direction of the other side of the polarization of the antenna pattern 810 may be the downward direction (\textcircled{4}) of the first dummy pattern 811. According to an embodiment, as the second dummy pattern 812 and the third dummy pattern 813 are additionally arranged, the antenna 81 may contribute to an increase in an absorption rate of surface waves generated in a polarization direction of the antenna pattern 810.

According to an embodiment, the second dummy pattern 812 and the third dummy pattern 813 may be formed as floating dummy patterns.

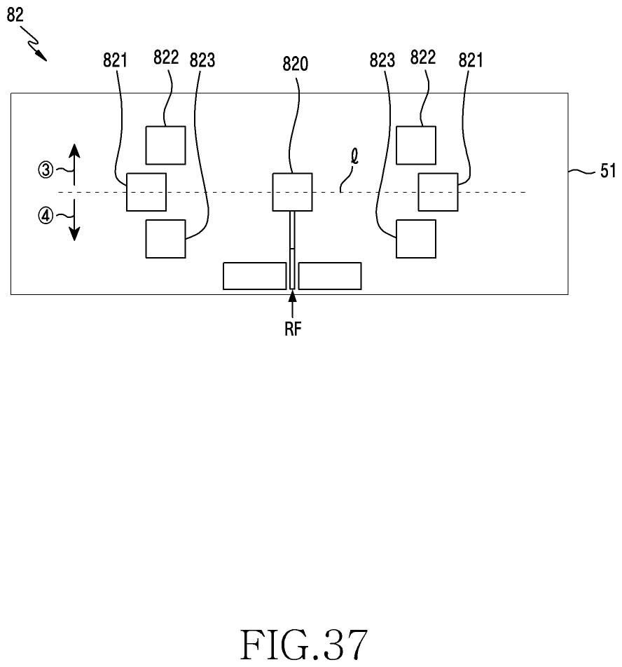

Referring to FIG. 37, according to an embodiment, a detailed description of substantially the same structure of an antenna 82 as the antenna 81 structure illustrated in FIG. 36 may not be repeated here, and only a different structure (e.g., dummy pattern arrangement) will be described. Reference symbol 1 may indicate a horizontal alignment line passing through the center of an antenna pattern 820, reference symbol \textcircled{3} may indicate an upward direction, and reference symbol \textcircled{4} may indicate a downward direction.

According to an embodiment, the antenna 82 may have a second dummy pattern 822 and a third dummy pattern 823 that are arranged in a state non-aligned with a first dummy pattern 821 in a polarization direction of the antenna pattern 820. For example, the non-aligned state may refer, for example, to the second dummy patterns 822 and the third dummy pattern 823 being arranged to be non-aligned with the first dummy pattern 821.

According to an embodiment, the second dummy pattern 822 may be arranged in the upward direction (\textcircled{3}), based on the horizontal alignment line (l), and the third dummy pattern 823 may be arranged in the downward direction (\textcircled{4}), based on the horizontal alignment line (l). According to an embodiment, the second dummy patterns 822 and the third dummy pattern 823 may be arranged symmetrically centering on the horizontal alignment line (l).

According to an embodiment, as the second dummy pattern 822 and the third dummy pattern 823 are additionally arranged, the antenna 82 may contribute to an increase in an absorption rate of surface waves generated in the polarization direction of the antenna pattern 820.

According to an embodiment, each of the first dummy pattern 821, the second dummy pattern 822, and the third dummy pattern 823 may be formed as a floating dummy pattern.

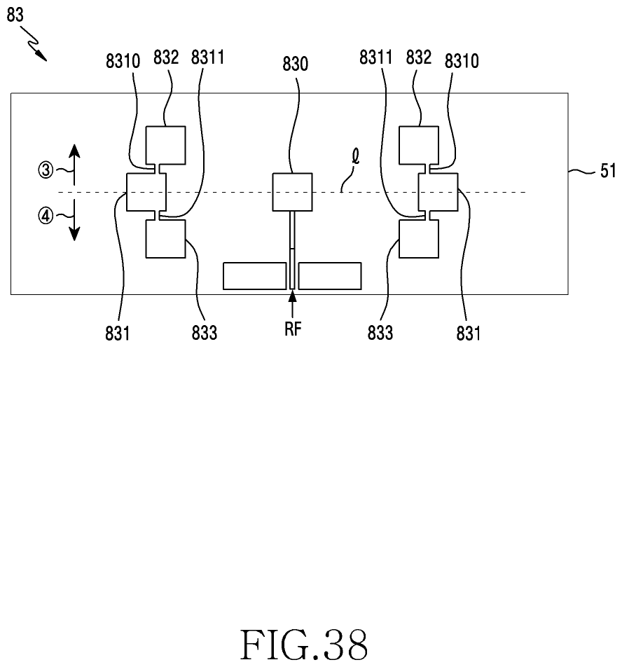

Referring to FIG. 38, according to an embodiment, a detailed description of substantially the same structure of an antenna 83 as the antenna 82 structure illustrated in FIG. 37 may not be repeated here, and only a different structure (e.g., dummy pattern connection) will be described.

According to an embodiment, the antenna 83 may have a second dummy pattern 832 and a third dummy pattern 833 that are arranged in a state non-aligned with a first dummy pattern 831 in a polarization direction of an antenna pattern 830. For example, the non-aligned state may refer, for example, to the second dummy pattern 832 and the third dummy pattern 833 being arranged to be non-aligned with the first dummy pattern 831 in the direction perpendicular to the polarization of the antenna pattern 830.

According to an embodiment, as the second dummy pattern 832 and the third dummy pattern 833 are additionally arranged, the antenna 83 may contribute to an increase in an absorption rate of surface waves generated in the polarization direction of the antenna pattern 830. According to an embodiment, the second dummy pattern 832 and the third dummy pattern 833 may be electrically connected to one end and the other end of the first dummy pattern 831 by a first connection pattern 8310 and a second connection pattern 8311, respectively.

According to an embodiment, the first dummy pattern 831, the second dummy pattern 832, and the third dummy pattern 833 may be formed as floating dummy patterns.

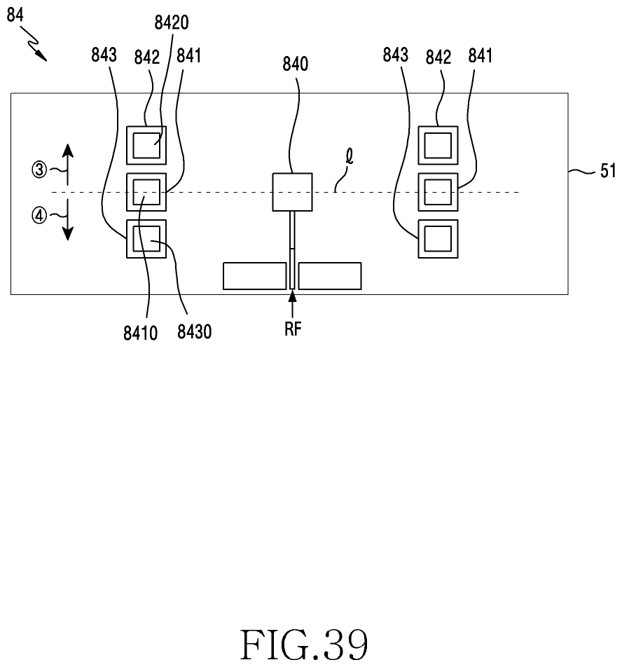

Referring to FIG. 39, according to an embodiment, a detailed description of substantially the same structure of an antenna 84 as the antenna 81 structure illustrated in FIG. 36 may not be repeated here, and only a different structure (e.g., dummy pattern shape) will be described.

According to an embodiment, a first dummy pattern 841, a second dummy pattern 842, and a third dummy pattern 843 may be conductive patterns having empty internal space central areas and for example, each of a first opening 8410, a second opening 8420, and a third opening 8430 having an approximately square or rectangular shape may be formed in the internal space central area. For example, the first opening 8410, the second opening 8420, and the third opening 8430 may have any one of a rectangular shape or square shape, but do not need to be limited to such a shape. According to an embodiment, the first dummy pattern 841 may be arranged to be spaced apart from an antenna pattern 840 in a state aligned in a direction perpendicular to the polarization of the antenna pattern 840, and the second dummy pattern 842 and the third dummy pattern 843 may be arranged in an upward direction (\textcircled{3}) and a downward direction (\textcircled{4}) from the first dummy pattern 841, respectively, based on a horizontal alignment line. For example, each of the first dummy pattern 841, the second dummy pattern 842, and the third dummy pattern 843 may be formed in a shape having a uniform width (e.g., thickness).

According to an embodiment, each of the first dummy pattern 841, the second dummy pattern 842, and the third dummy pattern 843 may be formed as a floating dummy pattern.

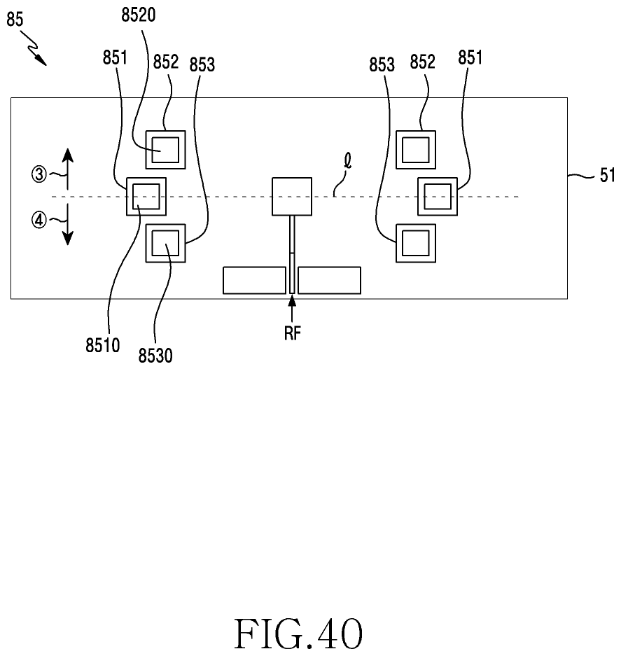

Referring to FIG. 40, according to an embodiment, a detailed description of substantially the same structure of an antenna 85 as the antenna 82 structure illustrated in FIG. 37 may not be repeated here, and only a different structure (e.g., dummy pattern shape) will be described.

According to an embodiment, each of a first dummy pattern 851, a second dummy pattern 852, and a third dummy pattern 853 may be a conductive pattern having an empty internal space center area, and a first opening 8510, a second opening 8520, and a third opening 8530 of an approximately square or rectangular shape may be formed in the internal space center areas. For example, the first opening 8510, the second opening 8520, and the third opening 8530 may have any one of a rectangular shape or square shape, but do not need to be limited to such a shape.

According to an embodiment, each of the first dummy pattern 851, the second dummy pattern 852, and the third dummy pattern 853 may be formed as a floating dummy pattern.

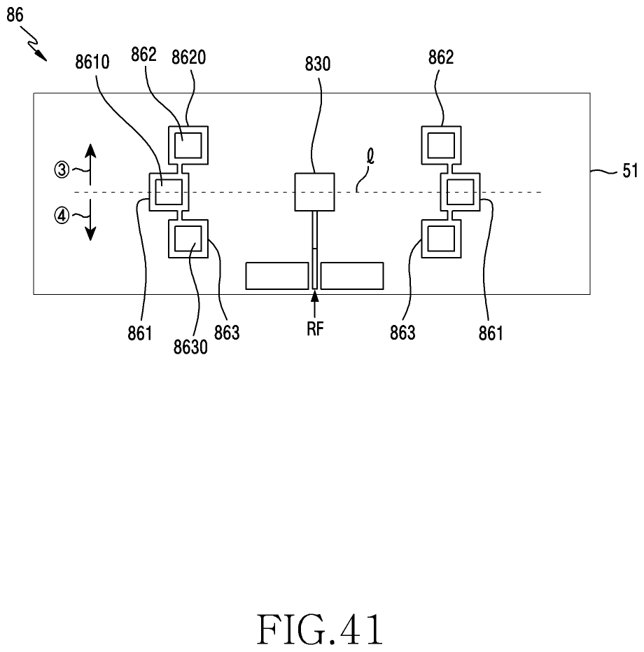

Referring to FIG. 41, according to an embodiment, a detailed description of substantially the same structure of an antenna 86 as the antenna 83 structure illustrated in FIG. 38 may not be repeated here, and only a different structure (e.g., dummy pattern shape) will be described.

According to an embodiment, each of a first dummy pattern 861, a second dummy pattern 862, and a third dummy pattern 863 may be a conductive pattern having an empty internal space center area, and a first opening 8610, a second opening 8620, and a third opening 8630 of an approximately square or rectangular shape may be formed in the internal space center areas, respectively.

According to an embodiment, each of the first dummy pattern 861, the second dummy pattern 862, and the third dummy pattern 863 may be electrically connected to each other and may be formed as a floating dummy pattern.

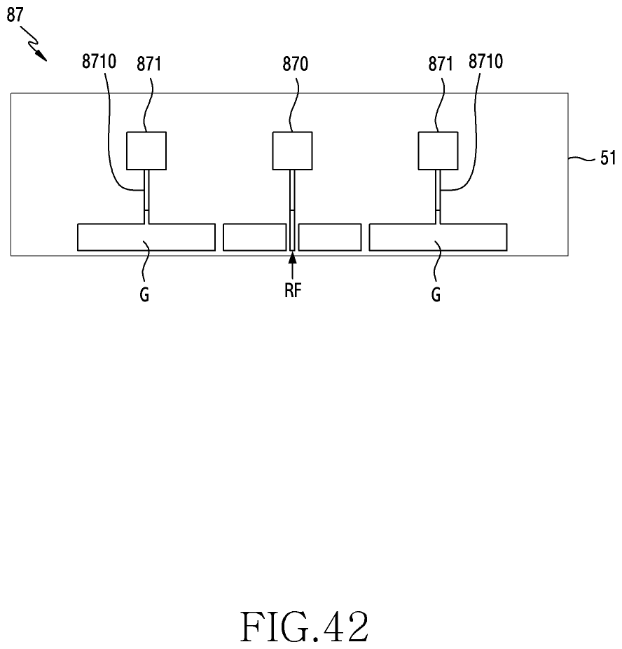

Referring to FIG. 42, according to an embodiment, a detailed description of the same structure of an antenna 87 as the antenna 75 structure illustrated in FIG. may not be repeated here, and only a different structure (e.g., ground pattern portion) will be described.

According to an embodiment, the antenna 87 may have a dummy pattern 871 arranged to be aligned with an antenna pattern 870 in a direction perpendicular 30 to the polarization of the antenna pattern 870. According to an embodiment, the dummy pattern 871 may be grounded to a ground pattern portion (G) by a ground line 8710 having a half wavelength.

According to an embodiment, the antenna 87 may connect the ground line 8710 of the dummy pattern 871 at a relatively longer length than the ground line 6910 of FIG. 24 and adjust the phase of a resonant frequency of the antenna pattern 870.

According to an embodiment, the dummy pattern 871 may be formed as a dummy pattern shorted from the ground pattern portion (G).

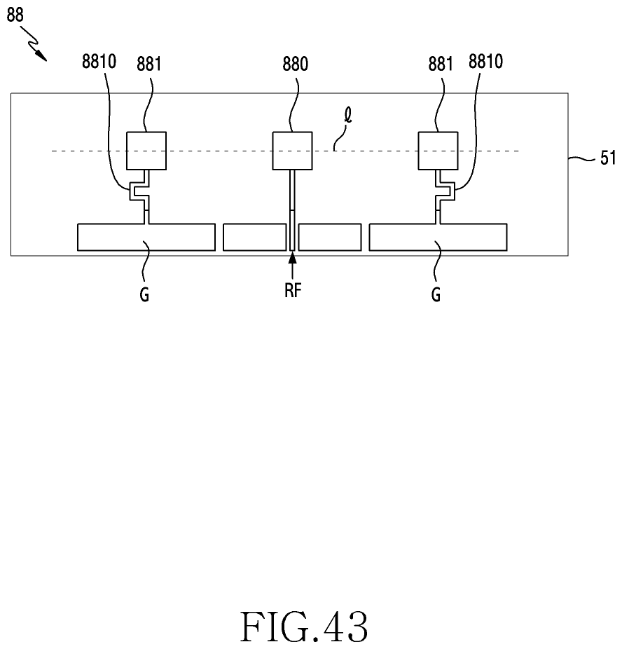

Referring to FIG. 43, according to an embodiment, a detailed description of the same structure of an antenna 88 as the antenna 87 structure illustrated in FIG. 42 may not be repeated here, and only a different structure (e.g., connection line) will be described.

According to an embodiment, the antenna 88 may have a dummy pattern 881 arranged to be aligned in a direction perpendicular to the polarization of an antenna pattern 880. According to an embodiment, the dummy pattern 881 may be grounded to a ground pattern portion (G) by a long ground line 8810.

According to an embodiment, the antenna 88 may connect the ground line 8810 of the dummy pattern 881 at a relatively longer length (e.g., half wavelength (λ/2)) than the ground line 8710 of FIG. 87 and adjust the phase of a resonant frequency of the dummy pattern 881.

According to an embodiment, the dummy pattern 881 may be formed as a dummy pattern shorted from the ground pattern portion (G).

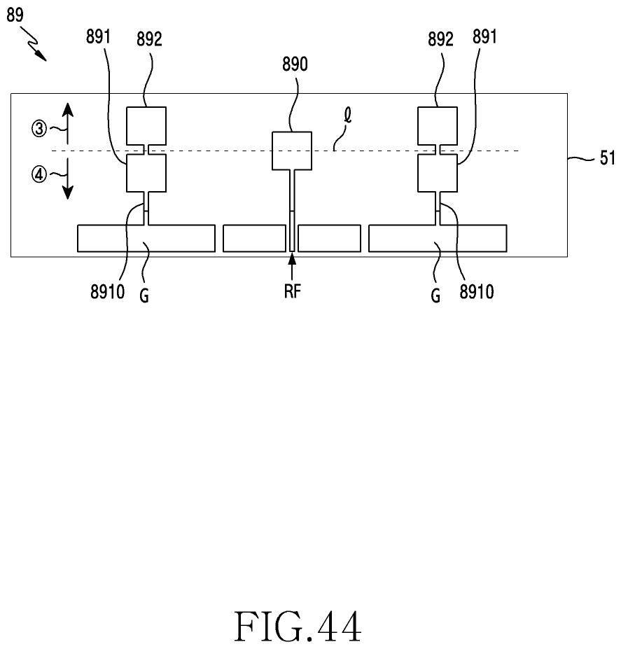

Referring to FIG. 44, according to an embodiment, a detailed description of substantially the same structure of an antenna 89 as the antenna 79 structure illustrated in FIG. 34 may not be repeated here, and only a different structure (e.g., connection line) will be described.

According to an embodiment, the antenna 89 may have a dummy pattern 891 and an additional dummy pattern 892 that are arranged in a direction perpendicular to the polarization of an antenna pattern 890 and are electrically connected to a ground pattern portion (G) by a ground line 8910.

According to an embodiment, the ground line 8910 may be formed longer than the ground line 6910 illustrated in FIG. 34, thereby adjusting the phase of a resonant frequency of the dummy pattern 891 and the additional dummy pattern 892.

According to an embodiment, the dummy pattern 891 and the additional dummy pattern 892 may be formed as dummy patterns shorted from the ground pattern portion (G).

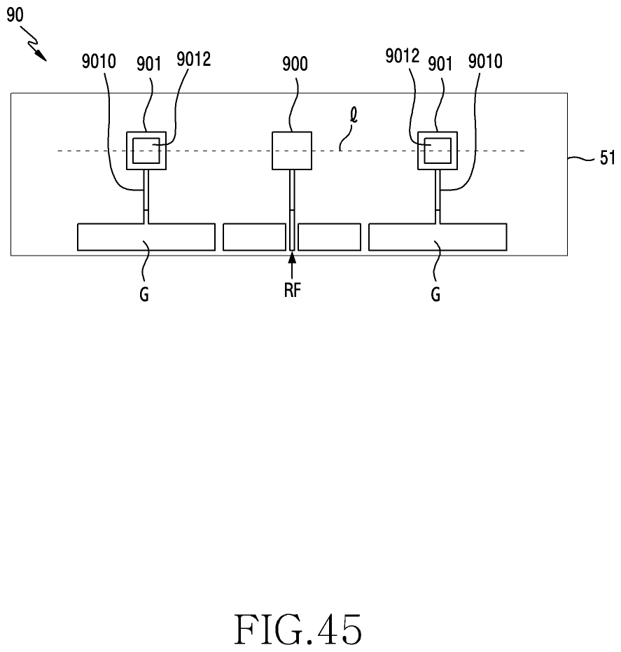

Referring to FIG. 45, according to an embodiment, a detailed description of substantially the same structure of an antenna 90 as the antenna 87 structure illustrated in FIG. 42 may not be repeated here, and only a different structure (e.g., dummy pattern shape) will be described.

According to an embodiment, a dummy pattern 901 may be a conductive pattern having an empty internal space center area, and an opening 9012 of an approximately square or rectangular shape may be each formed in the internal space center area. For example, the opening 9012 may have any one of a rectangular shape or square shape, but does not need to be limited to such a shape.

According to an embodiment, the antenna 90 may have the dummy patterns 901 and 902 arranged in a direction perpendicular to the polarization of an antenna pattern 900 and electrically connected to a ground pattern portion (G) by a ground line 9010.

According to an embodiment, the ground line 9010 may be formed longer than the ground line 6910 illustrated in FIG. 24, thereby adjusting the phase of a resonant frequency.

According to an embodiment, the dummy pattern 901 may be formed as a dummy pattern shorted from the ground pattern portion (G).

According to an example embodiment, an electronic device (e.g., electronic device 100 illustrated in FIG. 1) may include a housing (e.g., housing 310 illustrated in FIG. 3) including a first plate (e.g., first plate 41 illustrated in FIG. 4) arranged in a first direction (e.g., first direction (\textcircled{1}) illustrated in FIG. 4), a second plate (e.g., second plate 42 illustrated in FIG. 4) arranged in a second direction (e.g., second direction (\textcircled{2}) illustrated in FIG. 4) opposite to the first direction, and a side-surface member (e.g., side-surface member 43 illustrated in FIG. 4) surrounding at least a portion of a space between the first plate and the second plate, a display module (e.g., display module 453 illustrated in FIG. 4) including at least one dielectric layer (e.g., dielectric layer 452 illustrated in FIG. 5A) arranged in the second direction in at least a partial area of the first plate, and an antenna (e.g., antenna 46 illustrated in FIG. 4) disposed on the dielectric layer. The antenna may include an antenna member (e.g., antenna member 51 illustrated in FIG. 6) including an array of a plurality of mesh-shaped conductive patterns, at least one antenna pattern (e.g., antenna pattern 52 illustrated in FIG. 6) formed on the antenna member, and at least one first dummy pattern (e.g., first dummy pattern 53 illustrated in FIG. 6) arranged symmetrically in a direction perpendicular to polarization generated from the antenna pattern and arranged to be spaced apart from the antenna pattern.

According to an example embodiment, the first dummy pattern (e.g., first dummy pattern 53 illustrated in FIG. 6) may be arranged symmetrically in a state aligned with the antenna pattern and be spaced apart from the antenna pattern.

According to an example embodiment, the first dummy pattern (e.g., first dummy pattern 53 illustrated in FIG. 6) may be a conductive pattern and absorb surface waves generated in the direction perpendicular to the polarization of the antenna pattern.

According to an example embodiment, the first dummy pattern (e.g., first dummy pattern 53 illustrated in FIG. 6) may be an electrically insulated floating dummy pattern.

According to an example embodiment, the first dummy pattern (e.g., first dummy pattern 53 illustrated in FIG. 6) may be a dummy pattern grounded to a ground pattern portion (e.g., ground pattern portion (G) illustrated in FIG. 19) by a ground line (e.g., ground line 530 illustrated in FIG. 7).

According to an example embodiment, the length of the ground line (e.g., ground line 530 illustrated in FIG. 7) may be configured to be adjustable and the phase of a resonant frequency of the first dummy pattern may be adjustable.

According to an example embodiment, the first dummy pattern (e.g., first dummy pattern 53 illustrated in FIG. 7) may be formed in a pattern shape having an opening formed in an internal space central area.

According to an example embodiment, the first dummy pattern (e.g., first dummy pattern 53 illustrated in FIG. 7) may be formed in a pattern shape of a polygonal patch type.

According to an example embodiment, a second dummy pattern (e.g., second dummy pattern 54 illustrated in FIG. 9) may be further formed at one side of the first dummy pattern in a polarization direction of the antenna pattern (e.g., antenna pattern 52 illustrated in FIG. 9).

According to an example embodiment, the second dummy pattern (e.g., second dummy pattern 54 illustrated in FIG. 9) may be electrically connected to the first dummy pattern by a first conductive connection line (e.g., first conductive connection line 540 illustrated in FIG. 9).

According to an example embodiment, a third dummy pattern may be further formed at the other side of the first dummy pattern in the polarization direction of the antenna pattern (e.g., antenna pattern 52 illustrated in FIG. 6).

According to an example embodiment, the third dummy pattern may be electrically connected to the first dummy pattern (e.g., first dummy pattern 53 illustrated in FIG. 7) by a second conductive connection line.

According to an example embodiment, when the polarization of the antenna pattern (e.g., antenna pattern 601 illustrated in FIG. 13) is generated to slant at an inclination of 45 degrees, the at least one first dummy pattern (e.g., dummy pattern 605 illustrated in FIG. 13) may be arranged in a direction perpendicular to the slanted polarization of the antenna pattern.

According to an example embodiment, the dielectric layer (e.g., dielectric layer 452 illustrated in FIG. 5A) may include a film of an insulating material.

According to an example embodiment, the display module (e.g., display module 453 illustrated in FIG. 4) may include the dielectric layer (e.g., dielectric layer 452 illustrated in FIG. 4) including a first surface arranged in the first direction (e.g., first direction (\textcircled{1}) illustrated in FIG. 4) and a second surface arranged in a second direction (e.g., second direction (\textcircled{2}) illustrated in FIG. 4) opposite to the first direction, a polarizing layer (e.g., polarizing layer 451 illustrated in FIG. 5A) attached to the first plate (e.g., first plate 41 illustrated in FIG. 4) and being in close contact with the first surface of the dielectric layer, and a display panel (e.g., display panel 452 illustrated in FIG. 4) attached to the second surface of the dielectric layer.

While the disclosure has been illustrated and described with reference to

various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a housing comprising a first plate arranged in a first direction, a second plate arranged in a second direction opposite to the first direction, and a side-surface member comprising a bezel surrounding at least a portion of a space between the first plate and the second plate;
a display module including a display comprising at least one dielectric layer arranged in the second direction in at least a partial area of the first plate; and
an antenna disposed on the dielectric layer,
wherein the antenna comprises:
an antenna member comprising an array of a plurality of mesh-shaped conductive patterns;
at least one antenna pattern formed on the antenna member; and
at least one first dummy pattern arranged symmetrically in a direction perpendicular to polarization generated from the antenna pattern and arranged to be spaced apart from the antenna pattern.

2. The electronic device of claim 1, wherein the first dummy pattern is arranged symmetrically in a state aligned with the antenna pattern and is spaced apart from the antenna pattern.

3. The electronic device of claim 2, wherein the first dummy pattern includes a conductive pattern and is configured to absorb surface waves generated in the direction perpendicular to the polarization of the antenna pattern.

4. The electronic device of claim 1, wherein the first dummy pattern includes an electrically insulated floating dummy pattern.

5. The electronic device of claim 1, wherein the first dummy pattern includes a dummy pattern grounded to a ground pattern portion by a ground line.

6. The electronic device of claim 5, wherein a length of the ground line is configured to be adjustable and the phase of a resonant frequency of the first dummy pattern is configured to be adjustable.

7. The electronic device of claim 1, wherein the first dummy pattern has a pattern shape having an opening formed in an internal space central area.

8. The electronic device of claim 1, wherein the first dummy pattern has a pattern shape of a polygonal patch type.

9. The electronic device of claim 1, wherein a second dummy pattern is formed at one side of the first dummy pattern in a polarization direction of the antenna pattern.

10. The electronic device of claim 9, wherein the second dummy pattern is electrically connected to the first dummy pattern by a first conductive connection line.

11. The electronic device of claim 9, wherein a third dummy pattern is formed at an other side of the first dummy pattern in the polarization direction of the antenna pattern.

12. The electronic device of claim 11, wherein the third dummy pattern is electrically connected to the first dummy pattern by a second conductive connection line.

13. The electronic device of claim 1, wherein, based on the polarization of the antenna pattern being generated to slant at an inclination of about 45 degrees, the at least one first dummy pattern is arranged in a direction perpendicular to the slanted polarization of the antenna pattern.

14. The electronic device of claim 1, wherein the dielectric layer comprises a film comprising an insulating material.

15. The electronic device of claim 1, wherein the display module comprises:
the dielectric layer comprising a first surface arranged in the first direction and a second surface arranged in a second direction opposite to the first direction;
a polarizing layer attached to the first plate and being in contact with the first surface of the dielectric layer; and
a display panel attached to the second surface of the dielectric layer.

16. An antenna disposed in a display module of an electronic device, comprising:
an antenna member comprising an array of a plurality of mesh-shaped conductive patterns;
at least one antenna pattern formed on the antenna member; and
at least one dummy pattern arranged symmetrically in a direction perpendicular to polarization generated from the antenna pattern and arranged to be spaced apart from the antenna pattern.

17. The antenna of claim 16, wherein the dummy pattern is symmetrically aligned with and spaced apart from the antenna pattern in a direction perpendicular to the polarization of the antenna pattern.

18. The antenna of claim 17, wherein the dummy pattern includes a conductive pattern and is configured to absorb surface waves generated in the direction perpendicular to the polarization of the antenna pattern.

19. The antenna of claim 16, wherein the dummy pattern includes an electrically insulated floating dummy pattern.

20. The antenna of claim 16, wherein the dummy pattern includes a dummy pattern grounded to a ground pattern portion by a ground line.
